(19) United States
(12) Patent Application Publication
(10) Pub. No.: US 2009/0091235 A1
(43) Pub. Date: Apr. 9, 2009

(54) FLUORESCENT LAMP AND BACKLIGHT UNIT

(76) Inventors: Kazuhiro Matsuo, Osaka (JP); Mitsuharu Kawasaki, Kyoto (JP); Hiroyuki Arata, Hyogo (JP); Yuko Habuta, Hyogo (JP); Nozomu Hashimoto, Osaka (JP); Katsumi Itagaki, Kyoto (JP); Hideki Wada, Osaka (JP)

Correspondence Address: SNELL & WILMER L.L.P. (Panasonic), 600 ANTON BOULEVARD, SUITE 1400, COSTA MESA, CA, 92626, US

(21) Appl. No.: 11/914,537

(22) PCT Filed: Jul. 28, 2006
(86) PCT No.: PCT/JP2006/315443

§ 371 Date: Nov. 15, 2007

(30) Foreign Application Priority Data
Jul. 29, 2005 (JP) 2005-221206

(51) Int. Cl. H01J 1/62; H01J 9/38

(52) U.S. Cl. 313/486; 445/10

(57) ABSTRACT

A fluorescent lamp (20) includes a glass bulb (30) that has mercury enclosed therein, and a phosphor layer (32) formed on an inner side of the glass bulb (30). The phosphor layer (32) includes three types of phosphor particles, which are red phosphor particles (32R), green phosphor particles (32G) and blue phosphor particles (32B) that are excited by ultraviolet radiation to emit red light, green light and blue light respectively. The blue phosphor particles (32B) and green phosphor particles (32G) have a property of absorbing ultraviolet radiation with a wavelength of 313 nm.

### TECHNICAL FIELD

The present invention relates to fluorescent lamps and backlight units, and in particular to technology for preventing ultraviolet radiation from leaking out of the fluorescent lamps.

### BACKGROUND ART

(1) Backlight units are mounted on the back surfaces of liquid crystal panels, and are used as light sources for liquid crystal display apparatuses. Backlight units can be generally classified into edge-light units and direct-type units.

Direct-type backlight units include a housing which is open on the liquid crystal panel side for extracting light, and a plurality of cold-cathode fluorescent lamps disposed in the housing. The opening is covered by a plastic diffusion plate, diffusion sheet, lens sheet, and the like.

Due to their ability to use small-diameter glass bulbs, cold-cathode fluorescent lamps are often used in backlight units which require thinness and lightness. Also, mercury is enclosed in the glass bulbs as a luminescent material.

When a discharge occurs in a lamp, ultraviolet radiation whose emission spectrum has peaks at 254 nm, 313 nm, 365 nm, and the like is emitted from mercury. Part of this ultraviolet radiation passes through the glass bulb and reaches the components of the backlight unit. This causes resin components of the backlight unit such as the housing to degrade and discolor, thereby decreasing transparency and translucency. As a result, a surface luminance of the backlight unit drops, and the backlight unit will reach the end of its apparatus life.

Note that 254-nm and 313-nm ultraviolet radiation have a particularly large effect. 365-nm ultraviolet radiation is considered to not have much effect.

With regard to this, Japanese Patent Application Publication No. 2003-7252 discloses a cold-cathode fluorescent lamp that is able to suppress ultraviolet radiation from leaking out of the lamp by forming, on an inner wall surface of the glass bulb, a coating composed of a metal oxide such as titanium oxide.

(2) Generally, in fluorescent lamps of cold-cathode fluorescent lamps and the like, a phosphor layer including phosphors is formed on an inner side of a translucent container composed of a glass bulb or the like.

Mercury and an ionizing gas including more than one type of rare gas are enclosed in the glass bulb. Electrodes are disposed in the glass bulb near the ends thereof.

Upon initiating a positive column discharge between the electrodes, the mercury in the glass bulb is excited and ionized, and the excitation of the mercury is accompanied by the generation of resonance lines (wavelengths of 185 nm, 254 nm, 313 nm and 365 nm).

These resonance lines are converted into visible light by the phosphor layer formed on the inner side of the glass bulb.

In recent years, from the viewpoint of environmental protection, there has been increasing demand to reduce the amount of mercury used in fluorescent lamps. There is therefore a need for the development of technology that suppresses the amount of mercury that is consumed in glass bulbs. However, it is known that as the usage time passes, the mercury in fluorescent lamps is consumed as a result of the following phenomenon. When a fluorescent lamp is operated, the mercury diffuses into the glass bulb, and reacts with sodium (Na) which diffused from the glass bulb into the phosphor material, to form an amalgam. Mercury is therefore consumed due to adsorption to the phosphor material. The consumed mercury readily absorbs visible light, which is one of the causes for reduction in luminance.

FIG. 21 is a partial cross-sectional view of a phosphor layer of a conventional fluorescent lamp having a structure that attempts to solve the problem of mercury consumption (e.g., see International Publication WO 2002/047112 pamphlet, and Japanese Patent Application Publication No. 2004-6399). As shown in FIG. 21, a phosphor layer 500 is formed by depositing phosphor particles 520 on a glass bulb 530, and portions of surfaces of the phosphor particles 520 are covered by metal oxide bodies 510. The metal oxide bodies 510 are disposed between adjacent phosphor particles to form a like therebetween, and gaps between the phosphor particles have become narrower. The amount of mercury that penetrates into the phosphor layer 500 is reduced due to the presence of the metal oxide bodies 510, thereby suppressing the consumption of mercury resulting from adsorption to the phosphor material and the like.

However, as mentioned above, lamps that include the metal oxide coating require an extra step of forming this coating, which necessitates extra time.

In view of the above issue, a first object of the present invention is to provide a fluorescent lamp that has a simple structure and can suppress the leakage of ultraviolet radiation from the lamp, and a backlight unit that includes this fluorescent lamp.

Also, in lamps such as in Background Art (2), given that the metal oxide bodies 510 have a clumped shape, light converted by the phosphor layer is blocked by the clump-shaped metal oxide bodies 510, thereby making it difficult for light to escape from the glass bulb 530. Therefore, although the conventional lamps can suppress the consumption of mercury, their initial luminance is low.

A second object of the present invention is to provide a fluorescent lamp and the like that achieves both high luminance and the suppression of mercury consumption.

### DISCLOSURE OF THE INVENTION

In order to achieve the first object, the present invention is a fluorescent lamp including a glass bulb having mercury enclosed therein; and a phosphor layer formed on an inner side of the glass bulb and including three types of phosphor particles, the three types of phosphor particles being red phosphor particles, green phosphor particles and blue phosphor particles that are excited by ultraviolet radiation to emit red light, green light and blue light respectively, and at least two types of phosphor particles from among the three types of phosphor particles having a property of absorbing ultraviolet radiation with a wavelength of 313 nm.

According to this structure, given that 313-nm ultraviolet radiation generated during discharge is absorbed in the phosphor layer, it is possible to prevent 313-nm ultraviolet radiation from leaking out of the lamp without forming a separate coating for blocking ultraviolet radiation as is conventionally done. For this reason, if the fluorescent lamp of the present invention is used in, for example, a backlight unit, degradation to constituent elements of the backlight unit due to 313-nm ultraviolet radiation can be suppressed.

Also, one of the at least two types of phosphor particles that absorb ultraviolet radiation with a wavelength of 313 nm may be the blue phosphor particles, and the blue phosphor particles may be Eu-activated barium magnesium aluminate phosphor particles.

Also, one of the at least two types of phosphor particles that absorb ultraviolet radiation with a wavelength of 313 nm may be the green phosphor particles, and the green phosphor particles may be Eu/Mn-activated barium magnesium aluminate phosphor particles.

Also, the at least two types of phosphor particles may compose 50% or more by weight of a total weight composition of the three types of phosphor particles.

According to this structure, the leakage of 313-nm ultraviolet radiation from the lamp can be reliably prevented.

Also, a thickness of the phosphor layer may be in a range of 14 μm to 25 μm inclusive.

Also, the glass bulb may be borosilicate glass which has a property of absorbing ultraviolet radiation with a wavelength of 254 nm.

Also, yttrium oxide protective films may have been formed between the phosphor particles and on surfaces thereof.

Also, a backlight unit pertaining to the present invention may include the above-mentioned fluorescent lamp.

Also, a liquid crystal display apparatus pertaining to the present invention may include a liquid crystal display panel; and the above-mentioned back light unit.

Also, a direct-type backlight unit pertaining to the present invention includes a plurality of the above-mentioned fluorescent lamps; and a diffusion plate disposed on a light extracting side, and being a polycarbonate resin.

Also, in order to achieve the second object, in the fluorescent lamp pertaining to the present invention the phosphor layer may have rod-shaped bodies that include a metal oxide material and span between phosphor particles of the three types of phosphor particles.

According to this structure, light converted by the phosphor layer is readily transmitted out of the glass bulb since the phosphor particles included in the phosphor layer are spanned by rod-shaped bodies that include a metal oxide. The penetration of mercury into the phosphor layer is prevented by the metal oxide rod-shaped bodies, and the consumption of mercury due to adsorption to the phosphors etc. is suppressed. According to this structure, it is therefore possible to provide a fluorescent lamp that achieves both high luminance and the suppression of mercury consumption.

Also, among the phosphor particles, at least one pair of adjacent phosphor particles may be spanned by a plurality of the rod-shaped bodies.

Also, a thickness of each of the rod-shaped bodies may be no more than 1.5 μm.

Also, the metal oxide may include at least one member selected from the group consisting of Y, La, Hf, Mg, Si, Al, P, B, V and Zr.

Also, the metal oxide may include Y₂O₃.

Also, an inner diameter of the glass bulb may be in a range of 1.2 mm to 13.4 mm inclusive.

Also, a manufacturing method for a fluorescent lamp pertaining to the present invention includes a phosphor layer formation step of applying a coating material to an inner side of a translucent container, the coating material including a solvent that includes dispersed phosphor particles and a dissolved metal compound, vaporizing the solvent included in the applied coating material, and heating the coating material such that the compound metal becomes a metal oxide, to form a phosphor layer in which the phosphor particles are spanned by rod-shaped bodies that include the metal oxide; and a mercury enclosing step of, after formation of the phosphor layer, enclosing mercury in the translucent container, and the solvent including two or more types of solvents that each have a different boiling point.

Also, the metal compound may be an organic metal compound.

Also, the organic metal compound may include yttrium carboxylate.

Also, in the phosphor layer formation step, gas with a humidity in a range of 10% to 40% at 25° C. may be supplied into the translucent container while vaporizing the solvent.

### BRIEF DESCRIPTION OF THE DRAWINGS

FIG. 1 is a partially cutout view showing a schematic structure of a cold-cathode fluorescent lamp 20, and a partially enlarged view of a phosphor layer;

FIGS. 2A and 2B are tables that show names of the three types of phosphors, whether they absorb ultraviolet radiation with a wavelength of 313 nm, and total weight proportions, FIG. 2A showing an example of phosphors pertaining to conventional technology, and FIG. 2B showing phosphors pertaining to embodiment 1;

FIG. 3 is a graph showing results of an experiment that examined how an effect blocking ultraviolet radiation is influenced by proportions of phosphors absorbing 313-nm ultraviolet radiation to a total weight of phosphors;

FIGS. 4A and 4B show a structure of an external electrode fluorescent lamp 50 pertaining to embodiment 1, FIG. 4A schematically showing the external electrode fluorescent lamp 50, and FIG. 4B being an enlarged cross-sectional view, along a tube axis, of an end of the external electrode fluorescent lamp 50;

FIG. 5 is a schematic perspective view showing a structure of a direct-type backlight unit 1 pertaining to embodiment 1;

FIG. 6 is a cross-sectional view showing a schematic structure of an edge-light backlight unit 80;

FIG. 7 is a graph showing changes in an amount of moisture residue with time in the scintering step;

FIG. 8 shows a cross section of the phosphor layer;

FIG. 9 is a cross-sectional view of an exemplary fluorescent lamp of embodiment 2;

FIG. 10 is an enlarged conceptual view of an exemplary phosphor layer;

FIG. 11 is an enlarged conceptual view of another exemplary phosphor layer;

FIG. 12 is a flowchart describing an exemplary manufacturing method for a fluorescent lamp;

FIG. 13 describes a chemical reaction when using yttrium caprylate;

FIG. 14 is a plan view showing an exemplary lighting device;

FIG. 15 is a cross-sectional view taken along A-A of FIG. 14;

FIG. 16 is a perspective view of the exemplary lighting device;

FIG. 17 is a perspective conceptual view of an exemplary display apparatus;

FIG. 18 is a graph showing changes in a luminance maintenance rate according to elapsed operation time;

FIG. 19 is a graph showing a relationship between lamp current (mA) and peak wavelength intensity in a case of using lamps with differing phosphors;

FIG. 20 is a graph showing a relationship between impurity concentration (ppm) and relative luminance (%); and

FIG. 21 is an enlarged conceptual view of an exemplary phosphor layer included in a conventional fluorescent lamp.

### DESCRIPTION OF THE CHARACTERS

1 direct-type backlight unit
13 diffusion plate
20, 100 cold-cathode fluorescent lamp
30, 60 glass bulb (translucent container)
32, 64, 73, 102 phosphor layer
32B, 64B blue phosphor particles
32G, 64G green phosphor particles
32R, 64R red phosphor particles
50, external electrode fluorescent lamp
76 yttrium oxide coating (protective coating)
80 edge-light backlight unit
102a phosphor particles
102b rod-shaped bodies
104, 134 glass bulb
105 metal oxide layer
110 backlight unit
270 liquid crystal television
272 liquid crystal display panel

### BEST MODE FOR CARRYING OUT THE INVENTION

Embodiments of the present invention are described below with reference to the drawings.

### Embodiment 1

### 1.1 Structure of a Cold-Cathode Fluorescent Lamp

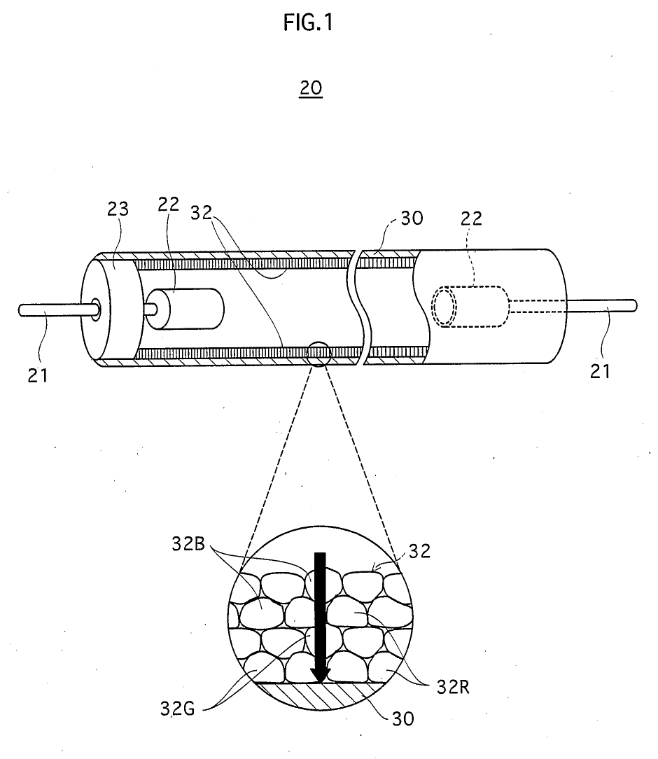

The following describes the structure of a cold-cathode fluorescent lamp 20 pertaining to the present embodiment with reference to the drawings. FIG. 1 is a partially cutout view showing a schematic structure of the cold-cathode fluorescent lamp 20, and a partially enlarged view of a phosphor layer.

The cold-cathode fluorescent lamp 20 has a glass bulb 30 that is a straight tube with respect to a substantially circular cross-section. The glass bulb 30 is composed of, for example, borosilicate glass. Note that the glass bulb 30 has a length of 720 mm, an outer diameter of 4.0 mm, and an inner diameter of 3.0 mm.

Note that the glass bulb 30 is not limited to borosilicate glass. Lead glass, lead-free glass, soda glass, or the like may be used. In this case, it is possible to improve an in-dark starting characteristic of the lamp. Specifically, glasses such as the above contain a large amount of alkali metal oxides such as sodium oxide (Na₂O), and in the exemplary case of sodium oxide, the sodium (Na) component elutes to the inner side of the glass bulb over time. The sodium that elutes to the inner ends of the glass bulb (without a protective film) is thought to contribute to improvement in the in-dark starting characteristic since sodium has a low electronegativity.

Also, it is preferable to use lead-free glass if environmental protection is taken into consideration. However, lead-free glass may acquire lead as an impurity in the manufacturing process. Lead-free glass is therefore defined as glass that contains lead at an impurity level of 0.1 wt % or less.

Note that it is preferable for the inner diameter to be from 1.2 mm to 5.5 mm, and the outer diameter to be from 1.6 mm to 6.5 mm.

Lead wires 21 are sealed in ends of the glass bulb 30 via bead glass 23. The lead wires 21 are continuous lines composed of, for example, an inner lead wire formed from tungsten (W) and an outer lead wire formed from nickel (Ni). An end of each of the inner lead wires 21 is fixed to a cold-cathode electrode 22.

Note that the interior of the glass bulb 30 is hermetically sealed as a result of the bead glass 23 and the glass bulb 30 being fused together, and the bead glass 23 and the lead wires 21 being affixed by frit glass. Also, the electrodes 22 and the lead wires 21 are affixed using laser welding or the like.

The electrodes 22 are so-called hollow electrodes which are cylindrical and have a bottom. Here, the reason for using a hollow electrode is its effectiveness in suppressing sputtering at the electrode, which occurs due to discharge during operation.

Mercury is enclosed inside the glass bulb 30 at a predetermined amount per volume of the glass bulb 30, such as 0.6 mg/cc. Rare gases such as argon (Ar), neon (Ne), etc. are enclosed in the interior of the glass bulb 30 at a predetermined pressure such as 60 Torr.

Note that here, the rare gas is a mixed gas containing argon (Ar) and neon (Ne) at a ratio of 5% Ar to 95% Ne.

A phosphor layer 32 is excited by ultraviolet radiation emitted from the mercury, and includes phosphors 32R, 32G, and 32B, which are three types of phosphors that convert the ultraviolet radiation into red, green, and blue light respectively.

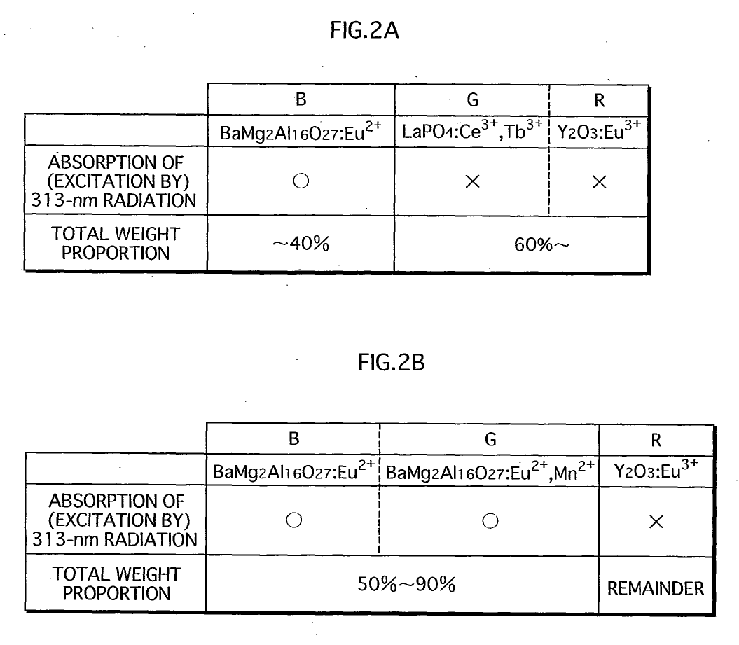

FIGS. 2A and 2B are tables that show names of the three types of phosphors, whether they absorb ultraviolet radiation with a wavelength of 313 nm, and total weight proportions. FIG. 2A shows an example of phosphors pertaining to conventional technology, and FIG. 2B shows phosphors pertaining to the present embodiment.

As shown in FIG. 2A, BaMg₂Al₁₆O₂₇:Eu²⁺ (BAM, Eu-activated barium magnesium aluminate phosphor) is used as the conventional blue phosphor, LaPO₄:Tb³⁺ (LAP) is used as the conventional green phosphor, and Y₂O₃:Eu³⁺ (YOX) is used as the conventional red phosphor. Out of these three types of phosphors, only the blue phosphor BAM has the property of absorbing 313-nm ultraviolet radiation (is excited by 313-nm ultraviolet radiation).

The total weight proportions of the three types of phosphors are determined according to the required color temperature, and the total weight proportion of BAM is at most roughly 40%. It is for this reason that 313-nm ultraviolet radiation leaks out of the glass bulb in conventional cold-cathode fluorescent lamps.

In contrast, as shown in FIG. 2B, BaMg₂Al₁₆O₂₇:Eu²⁺, Mn²⁺ (BAM:Mn²⁺, Eu/Mn-activated barium magnesium aluminate phosphor) is used as green phosphor particles in the present embodiment. Similarly to the blue phosphor BAM, this green phosphor has the property of absorbing 313-nm ultraviolet radiation. In this way, given that two types of the phosphor particles have the property of absorbing 313-nm ultraviolet radiation, 313-nm ultraviolet radiation is absorbed in the phosphor layer 32 (ultraviolet radiation is prevented from reaching the glass bulb 30), and 313-nm ultraviolet radiation is prevented from leaking out of the glass bulb 30 (out of the cold-cathode fluorescent lamp 20).

313-nm ultraviolet radiation is shown as a black arrow in the enlarged view at the bottom of FIG. 1. The 313-nm ultraviolet radiation is substantially blocked by the phosphor layer 32, and fails to reach the glass bulb 30. It is therefore possible to suppress solarization of the glass bulb 30 as well.

### 1.2 Preferred Proportions of Phosphors Absorbing 313-nm Ultraviolet Radiation

Next is a description of an experiment that examined how the effect of blocking ultraviolet radiation is influenced by the proportion of the phosphors absorbing 313-nm ultraviolet radiation to the total weight of the phosphors.

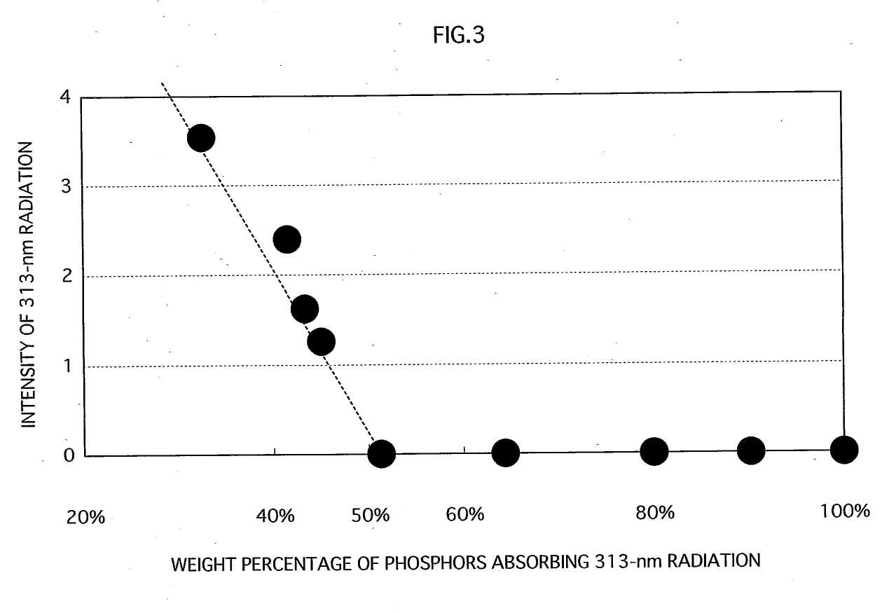

FIG. 3 is a graph showing results of the experiment. In the graph, a horizontal axis represents a weight percentage (%) of the phosphors absorbing 313-nm ultraviolet radiation with respect to the total weight of phosphor particles, while a vertical axis represents a radiation intensity (arbitrary unit) of 313-um ultraviolet radiation.

The experiment was performed by applying a constant current of 6 mA to operate a lamp (with an outer diameter of 3 mm and an inner diameter of 2 mm) with the same structure as the cold-cathode fluorescent lamp 20 described using FIG. 1, and measuring the intensity of 313-nm ultraviolet radiation that was emitted out of the lamp, at a center of the lamp in the longitudinal direction.

A thickness of the phosphor layer of the lamp used in the measurement was from 14 μm to 25 μm. A method for measuring thickness is mentioned later.

As shown in the graph of FIG. 3, it is understood that the blocking effect becomes larger as the total weight proportion of phosphors absorbing 313-nm ultraviolet radiation is increased, and in particular, 313-nm ultraviolet radiation was significantly prevented from leaking out of the lamp when the proportion was 50% or more.

Note that although it appears in the graph that the intensity of 313-nm ultraviolet radiation is zero when the above proportion is 50% or more, the radiation intensity is not actually zero, but rather a minute amount of radiation intensity was measured.

Also, a phosphor absorbing 313-nm ultraviolet radiation in the present embodiment is defined as a phosphor in which an intensity of an excitation wavelength spectrum of 313 nm is 80% or more when an intensity of an excitation wavelength spectrum around 254 nm is 100% (the excitation wavelength spectrum is a type of spectrum that plots an excitation wavelength and a light intensity when a phosphor is excited over a range of wavelengths, relative to an excitation wavelength at a maximum peak as 100). In other words, a phosphor absorbing 313-nm ultraviolet radiation is a phosphor capable of absorbing 313-nm ultraviolet radiation and converting it to visible light.

Note that, in the case of using blue and green phosphors that absorb 313-nm ultraviolet radiation as shown in FIG. 2B, 90% is an upper limit of the total weight proportion of these phosphors. However, this upper limit value can change according to a color range to be set when mixing the three colors of phosphors.

### 1.3 Structure of an External Electrode Fluorescent Lamp

The present invention can be applied to not only a cold-cathode fluorescent lamp, but also an external electrode fluorescent lamp.

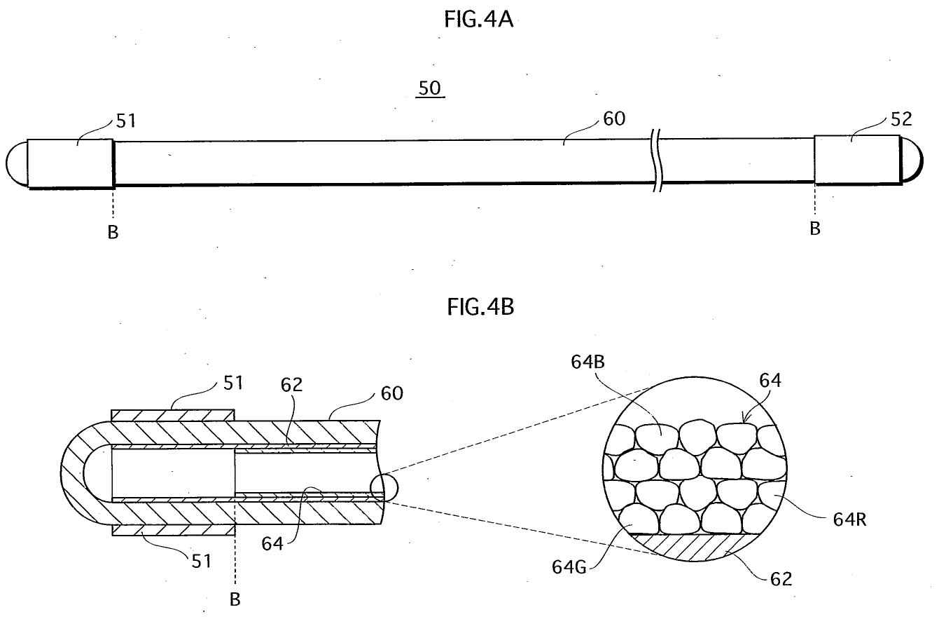

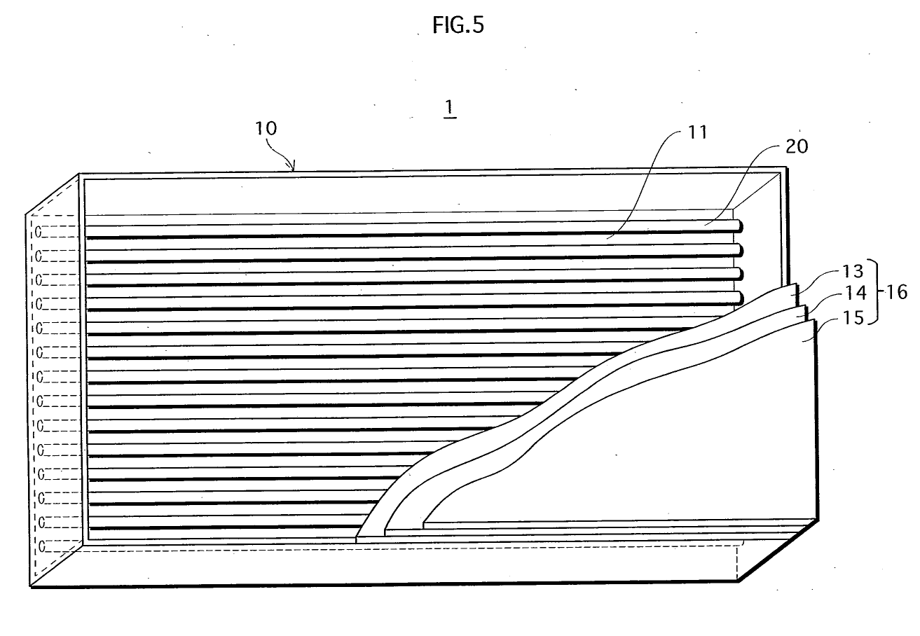

FIGS. 4A and 4B show a structure of an external electrode fluorescent lamp 50 pertaining to the present embodiment. FIG. 4A schematically shows the external electrode fluorescent lamp 50, and FIG. 4B is an enlarged cross-sectional view, along a tube axis, of an end of the external electrode fluorescent lamp 50.

As shown in FIG. 4A, the external electrode fluorescent lamp 50 includes a glass bulb 60 composed of a straight-tube cylindrical glass tube that is sealed at both ends, and external electrodes 51 and 52 that have been formed around an outer circumference of the ends of the glass bulb 60.

The glass bulb 60 is composed of, for example, borosilicate glass, and a cross-section thereof is substantially circular. The external electrodes 51 and 52 are composed of aluminum metal foil, and are affixed to the glass bulb 60 using a conductive adhesive including a silicone resin and a metal powder, so as to cover the outer circumferences of the ends of the glass bulb 60.

Note that the glass bulb 60 is not limited to borosilicate glass. Lead glass, lead-free glass, soda glass, or the like may be used. In this case, it is possible to improve an in-dark starting characteristic of the lamp. Specifically, glasses such as the above contain a large amount of alkali metal oxides such as sodium oxide (Na₂O), and in the exemplary case of sodium oxide, the sodium (Na) component elutes to the inner side of the glass bulb over time. The sodium that elutes to the inner ends of the glass bulb (without a protective film) is thought to contribute to improvement in the in-dark starting characteristic since sodium has a low electronegativity.

Particularly in external electrode fluorescent lamps in which external electrodes are formed so as to cover outer circumferences of the ends of the glass bulb, it is preferable for 3 mol % to 20 mol % of alkali metal oxides to be included in the glass bulb material.

For example, if the alkali metal oxide is yttrium oxide, it is preferable for 5 mol % to 20 mol % of yttrium oxide to be included in the glass bulb material. If the yttrium oxide content is less than 5 mol %, there is a higher probability that the in-dark starting time will exceed one second (in other words, there is a higher probability that the in-dark starting time will be less than one second if the yttrium oxide content is 5 mol % or more). If the yttrium oxide content is more than 20 mol %, there may be problems such as reduced luminance from whitening of the glass bulb due to long-term use, and a reduction in the strength of the glass bulb.

Also, it is preferable to use lead-free glass if environmental protection is taken into consideration. However, lead-free glass may acquire lead as an impurity in the manufacturing process. Lead-free glass is therefore defined as glass that contains lead at an impurity level of 0.1 wt % or less.

Note that fluoride resin, polyimide resin, an epoxy resin, etc. may be used as the conductive adhesive, instead of silicone resin. Also, instead of affixing the metal foil to the glass bulb 60 using the conductive adhesive, the external electrodes 51 and 52 may be formed by applying a silver paste around an entire circumference of electrode formation portions of the glass bulb 60. Furthermore, the external electrodes 51 and 52 may be given a cylindrical shape, or may be made caps that cover the ends of the glass bulb 60.

As shown in FIG. 4B, a protective layer 62 composed of, for example, yttrium oxide (Y₂O₃) is formed on an inner side of the glass bulb 60. The protective layer 62 functions to suppress a reaction between the glass bulb 60 and the mercury that is enclosed therein.

A phosphor layer 64 is deposited on the protective layer 62. As shown in FIG. 4A, assuming that positions of inner ends of the external electrodes 51 and 52 are B, the phosphor layer 64 is formed in an area corresponding to B-B of the glass bulb 60.

In the phosphor layer 64, BaMg₂Al₁₆O₂₇:Eu²⁺ (BAM) is used as blue phosphors particles 64B, BaMg₂Al₁₆O₂₇:Eu²⁺, Mn²⁺ (BAM:Mn²⁺) is used as green phosphor particles 64G, and Y₂O₃:Eu³⁺ (YOX) is used as red phosphor particles 64R.

### 1.4 Structure of a Backlight Unit

The cold-cathode fluorescent lamp 20 pertaining to the present invention can be used in a direct-type or edge-light (light guide plate) backlight unit. The following describes first a direct-type and second an edge-light backlight unit.

1.4.1 Direct-Type Backlight Unit

FIG. 5 is a schematic perspective view showing a structure of a direct-type backlight unit 1 pertaining to the present embodiment. In FIG. 5, a portion of a front panel 16 has been cut away to show an internal construction of the backlight unit 1.

The direct-type backlight unit 1 includes a plurality of cold-cathode fluorescent lamps 20, a housing 10 for storing the fluorescent lamps 20 and which is open on the liquid crystal panel side for extracting light, and the front panel 16 that covers the opening of the housing 10.

The cold-cathode fluorescent lamps 20 are straight tubes, and in the present embodiment, 14 of the cold-cathode fluorescent lamps 20 are disposed parallel in a lateral direction of the housing 10 such that their axes extend horizontally. Note that these cold-cathode fluorescent lamps 20 are operated using an electronic ballast not depicted in the figure.

The housing 10 is made from polyethylene terephthalate (PET) resin, and a metal such as silver has been vapor deposited on an inner side 11 of the housing 10 to form a reflective surface. Note that the housing 10 may be constituted from a metallic material such as aluminum, instead of a resin.

The opening of the housing 10 is covered by the translucent front panel 16, and is hermetically sealed such that foreign substances such as dust and dirt cannot enter the housing 10. The front panel 16 is formed by laminating a diffusion plate 13, a diffusion sheet 14, and a lens sheet 15.

The diffusion plate 13 and the diffusion sheet 14 scatter and diffuse light emitted from the cold-cathode fluorescent lamps 20, and the lens sheet 15 aligns the light in a normal direction of the sheet 15. As a result, the light emitted from the cold-cathode fluorescent lamps 20 radiates evenly across and entirety of a surface (light emitting surface) of the front panel 16.

Note that the diffusion plate 13 is made from a PC (polycarbonate) resin material. PC resin has excellent moisture resistance, mechanical strength, heat resistance, and optical transparency properties, and is often used in diffusion plates for large-screen (e.g., 17 inches or more) liquid crystal display televisions due to the fact that the absorption of moisture causes very little warpage in PC resin plates.

On the other hand, compared to acrylic resin diffusion plates which are used in small liquid crystal display televisions, PC resin readily becomes degraded and discolored due to the affects of ultraviolet radiation.

The inventors of the present invention have confirmed that, whereas there are almost no problems with the affects of 313-nm ultraviolet radiation on acrylic resin diffusion plates, there are cases in which PC resin diffusion plates become significantly degraded and discolored due to 313-nm ultraviolet radiation.

The cold-cathode fluorescent lamps 20 pertaining to the present embodiment can prevent the leakage of 313-nm ultraviolet radiation due to the inclusion of phosphors that absorb 313-nm ultraviolet radiation, and even when using a PC resin diffusion plate which readily degrades due to 313-nm ultraviolet radiation, it is possible to maintain the properties of the diffusion sheet for an extended period of time.

1.4.2 Edge-Light Backlight Unit

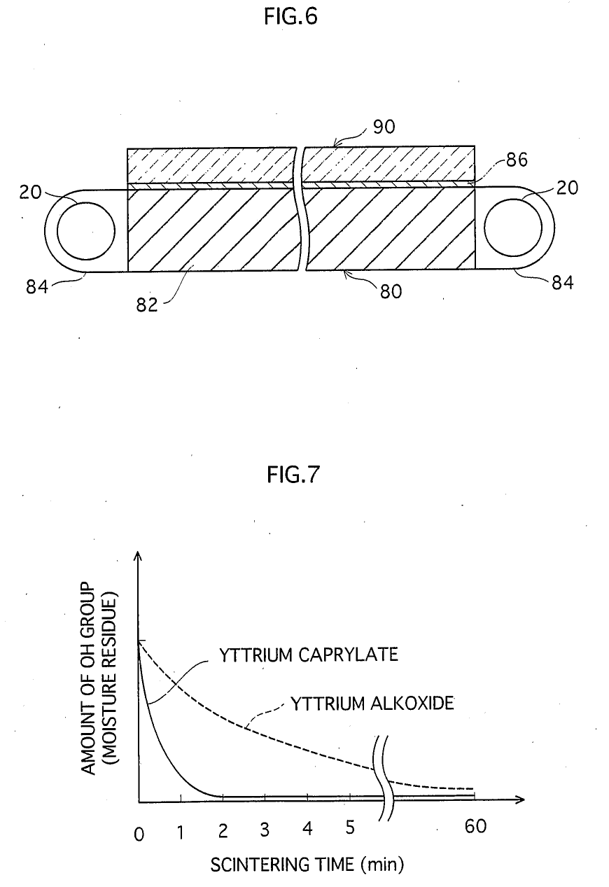

FIG. 6 is a cross-sectional view showing a schematic structure of an edge-light backlight unit 80.

The backlight unit 80 includes a light guide plate 82 made from translucent acrylic resin, two cold-cathode fluorescent lamps 20 provided at end faces of the light guide plate 82, a reflecting plate 84 that reflects light emitted from the cold-cathode fluorescent lamps 20 toward the light guide plate 82, and a sheet layer 86 provided on a principal surface (surface on the light extracting side) of the light guide plate 82.

A liquid crystal panel 90 is disposed on a front face of the backlight unit 80.

The sheet layer 86 is formed by laminating a plurality of sheets such as a prism sheet for improving brightness (e.g., a BEF (Brightness Enhancement Film) manufactured by 3M Corp.), and a light diffusing sheet for enlarging the viewing angle.

There are cases in which a material that readily degrades due to 313-nm ultraviolet radiation is included in the sheets constituting the sheet layer 86. Using the cold-cathode fluorescent lamps 20 of the present embodiment enables suppression of this degradation.

### 1.5 Other

1.5.1 Examples of Phosphors Absorbing 313-Nm Ultraviolet Radiation

Although the blue and green phosphors have the property of absorbing 313-nm ultraviolet radiation in the present embodiment, a red phosphor having the same property may be also used. Specifically, Y(P,V) O₄:Eu³⁺ or 3.5MgO.0.5MgF₂.GeO₂:Mn⁴⁺ (MFG) may be used as such a red phosphor. The leakage of 313-nm ultraviolet radiation from the lamp can be prevented more effectively if the three types of phosphors all have the property of absorbing 313-nm ultraviolet radiation.

The following are examples of applicable phosphors that have the property of absorbing 313-nm ultraviolet radiation. There are no limitations on the combination of phosphors.
Blue phosphor: BaMg₂Al₁₆O₂₇:Eu²⁺, Sr₁₀(PO₄)₆Cl₂:Eu²⁺, (Sr, Ca, Ba)₁₀(PO₄)₆Cl₂:Eu²⁺, Ba_{1-x-y}SrₓEu_{y}Mg_{1-z}Mn_{z}Al₁₀O₁₇ (provided that x, y, and z are numbers that satisfy the conditions 0≦x≦0.4, 0.07≦y≦0.25, and 0.1≦z≦0.6, and it is particularly preferable for z to satisfy the condition 0.4≦z≦0.5)
Green phosphor: BaMg₂Al₁₆O₂₇:Eu²⁺, Mn²⁺, MgGa₂O₄:Mn²⁺, CeMgAl₁₁O₁₉: Tb³⁺
Red phosphor: YVO₄:Eu³⁺, YVO₄:Dy³⁺ (emits green and red light)

Note that a mixture of phosphors of different compounds may be used for one color. One example is to use BAM for blue, LAP (does not absorb 313-nm ultraviolet radiation) and BAM:Mn²⁺ for green, and YOX (does not absorb 313-nm ultraviolet radiation) and YVO₄:Eu³⁺ for red. In such a case, the leakage of ultraviolet radiation from the glass bulb can be reliably prevented by adjusting the phosphors such that the phosphors absorbing 313-nm ultraviolet radiation comprise 50% or more of the total weight proportion.

1.5.2 Thickness of a Phosphor Layer

As mentioned in the present embodiment, a thickness of the phosphor layer 32 (see FIG. 1) is preferably from 14 μm to 25 μm (more preferably, from 16 μm to 22 μm).

The thickness referred to here is an average thickness of the phosphor layer 32 at four arbitrary positions such as 0, 90, 180, and 270 degrees from a center of a cross section of the glass bulb 30 observed using an SEM (scanning electron microscope). Here, if a surface of the phosphor layer 101 at any of the four positions is not flat, a thickness of a thickest portion is measured.

If the thickness of the phosphor layer 32 is less than 14 μm, ultraviolet radiation generated in the glass bulb 30 is more likely to pass through the glass bulb 30 without, being converted to visible light, and so a sufficient visible light conversion efficiency cannot be attained. If the thickness of the phosphor layer 32 is more than 25 μm, light is more likely to be blocked by the phosphor layer 32, and so sufficient visible light conversion efficiency cannot be attained.

1.5.3 254-nm Ultraviolet Radiation

Although not mentioned in detail in the present embodiment, 254-nm ultraviolet radiation may also degrade constituent elements of the backlight unit. In order to avoid this situation, borosilicate glass which has the property of absorbing 254-nm ultraviolet radiation is used in the glass bulb 30 (see FIG. 1) of the present embodiment.

This property can be realized by doping the glass with a transition metal oxide in a predetermined amount that depends on the type of the transition metal oxide. For example, the above property can be realized by doping the glass with about 0.05 mol % or more of titanium oxide (TiO₂) However, given that glass devitrifies if the composition ratio of titanium oxide is greater than 5.0 mol %, it is desirable for the composition ratio to be 0.05 mol % to 5.0 mol % inclusive.

The above property can also be realized by doping the glass with 0.05 mol % or more of cerium oxide (CeO₂). However, given that glass becomes discolored if the composition ratio of cerium oxide is greater than 0.5 mol %, it is desirable for the composition ratio of the cerium oxide to be 0.05 mol % to 0.5 mol % inclusive. Note that the glass can be doped with up to about 5.0 mol % of cerium oxide since the discoloration of the glass can be suppressed by additional doping with tin oxide (SnO) However, in this case as well, the glass devitrifies if doped with more than 5.0 mol % of cerium oxide.

The above property can also be realized by doping the glass with 2.0 mol % or more of zinc oxide. However, it is desirable for the glass to be doped with 2.0 to 10 mol % inclusive of zinc oxide since the thermal expansion coefficient of the glass rises if a composition ratio of the zinc oxide is over 10 mol %. If tungsten (W) is used in the lead lines in this case, there will be a difference in the thermal expansion coefficients of the glass and the lead lines (tungsten has a thermal expansion coefficient of 44×10⁻⁷K⁻¹), making sealing difficult.

The above property can also be realized by doping the glass with 0.01 mol % or more of iron oxide (Fe₂O₃). However, given that glass becomes discolored if the composition ratio of iron oxide is greater than 2.0 mol %, it is desirable for the composition ratio of the iron oxide to be 0.01 mol % to 2.0 mol % inclusive.

1.5.4 Phosphor Layer Formation Method

In the present embodiment, BAM phosphors are used as the blue phosphors. These BAM phosphors are generally known to readily degrade in a sintering step.

In view of this, a phosphor layer formation method that can suppress the degradation of the BAM phosphors in a sintering step is described below.

In general, a phosphor layer is formed through four steps: (A) adjusting a phosphor layer suspension; (B) applying the phosphor layer suspension to a glass bulb; (C) drying; and (D) sintering (baking).

The inventors of the present invention have learned that the degradation of the BAM phosphors in the sintering step occurs for the following reason. When the sintering is performed at a temperature of 300° C. to 500° C., moisture adsorbs to the phosphors, as a result of which the phosphors degrade.

Here, the moisture adhering to the phosphors can be removed to a certain extent by reheating at about 200° C. to 300° C. However, once the temperature has dropped to a room temperature or the like after the reheating, moisture may adsorb to the phosphors again. Hence this method cannot produce a sufficient effect.

The inventors of the present invention have found out that this problem can be solved by adding a carboxylate metal salt to the phosphor layer suspension so that the carboxylate metal salt adheres to the phosphors in the adjustment step (A), and causing the carboxylate metal salt, whose decomposition temperature is in a range of 300° C. to 600° C., to react with the moisture to thereby form a metal oxide in the baking step (D).

It is preferable to use yttrium caprylate, yttrium 2-ethylhexanoate, or yttrium octylate as the carboxylate metal salt.

For example, when yttrium caprylate is used, a reaction formula showing a transition of reaction of yttrium caprylate in the above baking step is:

Y(C₇H₁₅COO)₃+H₂O →Y−(OH)₃+3C₇H₁₅COOH →Y₂O₃+H₂O+CO₂

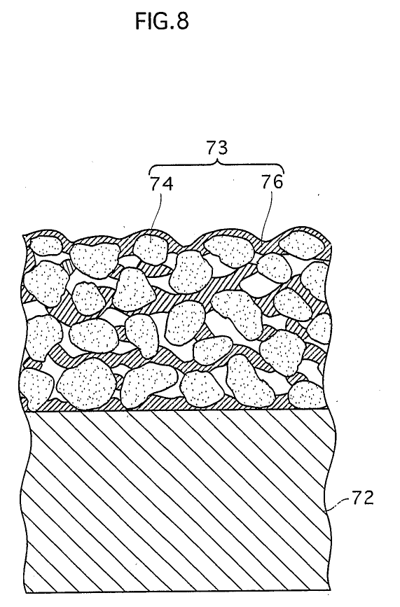

In, the sintering step, yttrium caprylate absorbs moisture and thereby forms yttrium oxide, in a temperature range where moisture adsorption to the phosphors occurs. In this way, moisture adsorption to the phosphors in the baking step can be avoided. Yttrium caprylate also reacts with a part of a surface of the phosphors to which moisture tends to adhere, thereby forming an yttrium oxide coating on this part (this coating will be described later with reference to FIG. 8).

As a result, it is possible to significantly reduce the reattachment of moisture to the surface of the phosphors (e.g. moisture adsorption hardly occurs even when the phosphors have been left at room temperature after sintering).

Next is a description of an example of measuring a moisture residue on the phosphor layer when yttrium caprylate is used.

FIG. 7 is a graph showing changes in an amount of OH group (moisture residue) with time in the scintering step. Yttrium caprylate is indicated by a solid line, whereas Yttrium alkoxide is indicated by a broken line. The moisture residue was evaluated based on absorption of light in an OH group absorption band (4300 1/cm), using an FT-IR spectrometer. Each compound was dissolved by butyl acetate, spin-coated on a silicon wafer so as to have a thickness of 0.1 μm, and dried at 100° C. for 30 minutes. After this, changes in moisture residue were observed at 550° C. which is a temperature used in the sintering step.

As shown in FIG. 7, when using yttrium caprylate, moisture was removed in a very short time of a few minutes. This demonstrates that the phosphor layer formation method of embodiment 1 can be effectively used in a phosphor baking step in volume production of lamps.

When using yttrium alkoxide, on the other hand, moisture was not removed much. This can be attributed to the fact that yttrium (Y), which is a metal atom, is attacked by the OH group during a hydrolysis reaction.

In comparison, when yttrium caprylate is used, an organic functional group which is combined with yttrium (Y) effectively acts as a steric hindrance to the OH group, thereby suppressing the reaction between yttrium and the OH group.

According to the phosphor layer formation method described above, a lamp that contains a greater amount of BAM phosphors, which are conventionally known to suffer a significant decrease in luminance maintenance rate due to Hg adsorption or the like, can exhibit a long life and a high luminance maintenance rate.

The inventors of the present invention have confirmed that the luminance maintenance rate can be improved by 5% to 10% at 3000 hours.

Also, a color shift (an amount of change in chromaticity x and y) at 3000 hours can be reduced to ½. Thus, a decrease in color reproducibility can be prevented even after extended use.

It should be noted here that the above phosphor layer formation method can be applied not only to BAM phosphors but also to other types of phosphors, and can produce similar effects.

Next is a description of a condition of the phosphor layer obtained after the baking step according to the above phosphor layer formation method.

FIG. 8 shows a cross section of the phosphor layer that was formed. FIG. 8 is associated with FIG. 1, and shows the phosphor layer of the cold-cathode fluorescent lamps 20.

A phosphor layer 73 on an inner side of a glass bulb 72 is composed of phosphor particles 74 and yttrium oxide coatings (protective films) 76 that span between and cover surfaces of the phosphor particles 74.

The yttrium oxide coatings 76 cover a surface of the phosphor layer 73 and the surfaces of the phosphor particles 74, and span between the phosphor particles 74.

These yttrium oxide coatings 76 have an effect of isolating the mercury, which is enclosed in the lamp, from the phosphor particles 74 and the glass bulb 72.

This makes it possible to prevent the degradation of the phosphor particles 74 caused by a chemical reaction with mercury, and the consumption of the mercury in the discharge space caused by adsorption to the glass bulb 72.

### Embodiment 2

The following is a description of embodiment 2.

2.1 Outline of a Structure and Manufacturing Method of a Fluorescent Lamp

In an exemplary fluorescent lamp of the present invention, a rod-shaped body has an inter-phosphor particle length which is longer than its width in the diameter direction, and has a thickness of 1.5 μm or less. Also, a pair of adjacent phosphor particles may be spanned by a plurality of rod-shaped bodies. Here, the “thickness” of a rod-shaped body can be seen when observed using a high resolution scanning electron microscope (HRSEM), and refers to the thickness at ½ of the longitudinal length of the rod-shaped body (the length in the inter-phosphor particle direction).

It is preferable for a metal oxide to be at least one member selected from among, specifically, Y, La, Hf, Mg, Si, Al, P, B, V and Zr. It is particularly preferable for the metal to be Y. The consumption of mercury is further reduced if the metal oxide contains an yttrium oxide such as Y₂O₃.

In the exemplary fluorescent lamp of the present invention, a translucent container is tubular glass with a small inner diameter of 1.2 mm to 13.4 mm. It is very beneficial to apply, to the fluorescent lamp with a small diameter, a phosphor layer including phosphor particles that are spanned by rod-shaped bodies composed of a metal oxide.

In an exemplary manufacturing method of the fluorescent lamp of the present invention, it is preferable to use an organic metal compound such as yttrium carboxylate as the metal compound. In this case, it is preferable to supply a gas with a humidity (relative humidity) of 10% to 40% at 25° C. into the translucent container while performing vaporization of a solvent in a phosphor layer formation step. It is unclear why, but uniformity of thickness etc. of the phosphor layer deteriorates if the humidity in the translucent container is too low, and vaporization of the solvent takes too long if the humidity is too high, thereby reducing production efficiency. Performing vaporization of the solvent by supplying the gas with a humidity of 10% to 40% at 25° C. into the translucent container enables efficient formation of a phosphor layer with excellent uniformity. Although differing according to the type of solvent included in the coating material, it is usually suitable for an atmospheric temperature during vaporization of the solvent to be 25° C. to 50° C.

The exemplary fluorescent lamp of the present invention is preferably used as, for example, a light source included in a lighting device. One example of the lighting device includes, for example, a plurality of the exemplary fluorescent lamps of the present invention, which are stored in a casing that includes a window able to transmit light emitted by the fluorescent lamps.

The exemplary lighting device is preferably used as, for example, a backlight unit included in a display apparatus of a liquid crystal display apparatus or the like. In one example of the liquid crystal display apparatus, the lighting device is, for example, disposed on a back face of the display panel.

### 2.2 Structure of a Cold-Cathode Fluorescent Lamp

The following is a specific description of the structure of a cold-cathode fluorescent lamp with reference to the drawings.

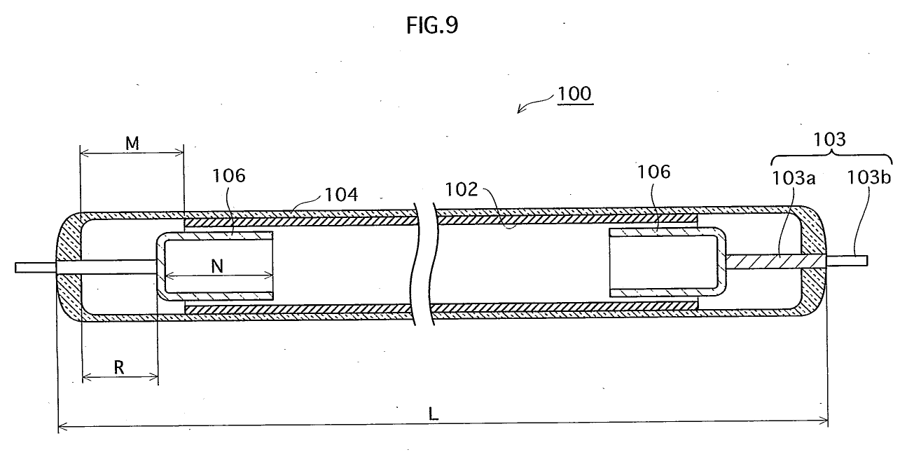

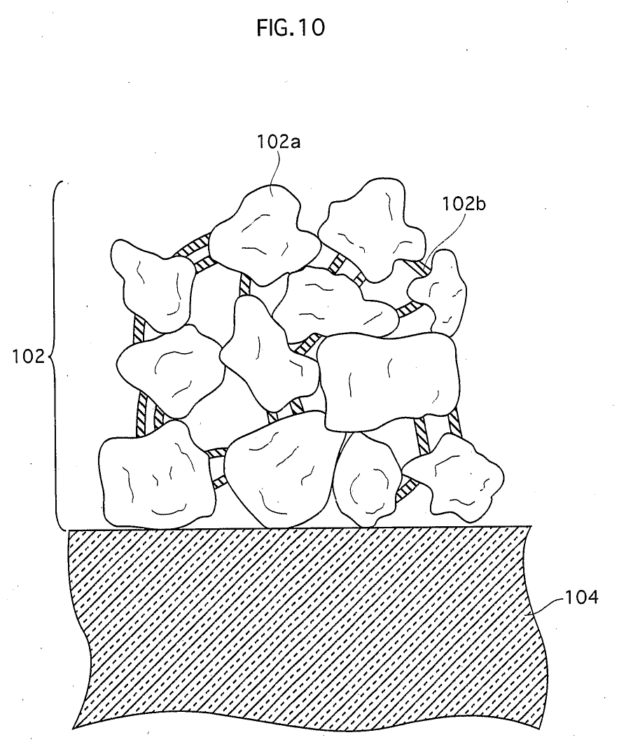

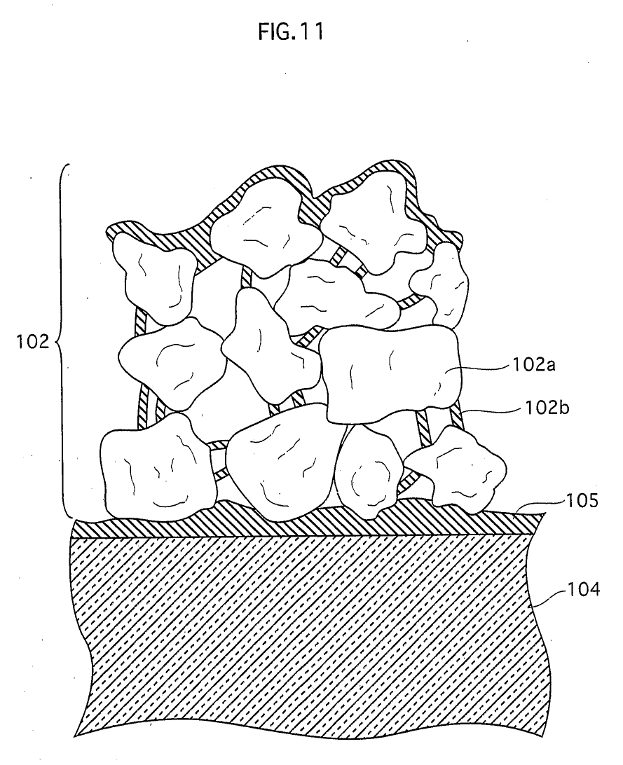

FIG. 9 is a cross-sectional view of an exemplary fluorescent-lamp of the present embodiment, and FIG. 10 is an enlarged conceptual view of a phosphor layer included in the fluorescent lamp shown in FIG. 9.

As shown in FIG. 9, in a cold-cathode fluorescent lamp 100, ends of a glass bulb (translucent container) 104 having a circular cross section are each hermetically sealed by lead wires 103, and inner ends of the lead wires 103 inside the glass bulb 104 are each connected to electrodes 106. A phosphor layer 102 has been formed on a predetermined area of an inner side of the glass bulb 104.

As shown in FIG. 10, the phosphor layer 102 includes phosphor particles 102a, and the phosphor particles 102a are spanned by rod-shaped bodies 102b that include a metal oxide. The rod-shaped bodies 102b have a thickness of, for example, 1.5 μm or less. There are cases in which a pair of adjacent phosphor particles 102a are spanned by a plurality of the rod-shaped bodies 102b. The presence of the rod-shaped bodies 102b narrows gaps between the phosphor particles 102a, and suppresses the penetration of mercury into the phosphor layer 102.

This therefore suppresses the consumption of mercury from adsorption to the phosphor particles 102a.

Also, given that the metal oxide bodies disposed between the phosphor particles 102a and spanning therebetween are rod-shaped, light converted by the phosphor layer 102 is readily transmitted outside the glass bulb 104.

According to this structure, the fluorescent lamp 100 of the present embodiment achieves both high luminance and the suppression of the consumption of mercury, as is shown in working examples mentioned hereinafter.

It is preferable for the metal oxide to be at least one member selected from among, for example, Y, La, Hf, Mg, Si, Al, P, B, V and Zr. Among these, Zr, Y, Hf and the like are preferable since their coupling energy with an oxygen atom exceeds 10.7×10⁻⁹ J. This 10.7×10⁻⁹ J corresponds to the photon energy of 185-nm ultraviolet radiation, which is one of the resonance lines generated along with the excitation of mercury. Using, for example, ZrO₂, Y₂O₃, or HfO₂ as the metal oxide including a metal whose coupling energy with an oxygen atom exceeds 10.7×10⁻⁹ J improves the resistance of the metal oxide to exposure to 185-nm ultraviolet radiation. Also, using a metal oxide that includes Y₂O₃ further reduces the consumption of mercury, which is preferable.

SiO₂, Al₂O₃, HfO₂, or the like may be used as the metal oxide. These have a high (substantially 100%) transmissivity for light with a wavelength of 254 nm. Phosphors emit visible light by receiving 254-nm light. Therefore, using a metal oxide that has a high transmissivity for 254-nm light increases luminous efficiency, which is preferable.

Note that the rod-shaped bodies 102b can be called needle-shaped bodies.

Note that ZrO₂ has a transmissivity of approximately 95% for 254-nm light, and V₂O₅, Y₂O₃ and NbO₅ have a transmissivity of approximately 85% for 254-nm light. Y₂O₃ and ZrO₂ have a low transmissivity for light with a wavelength of 200 nm or less, which are specifically less than 30% and 20% respectively. For this reason, Y₂O₃ and ZrO₂ have a large effect of blocking 185-nm light that degrades phosphors, which is preferable.

The phosphor layer 102 is formed on the inner side of the glass bulb 104, except for, for example, the ends thereof. While there are no particular restrictions, it is suitable for a distance M from an end surface of the glass bulb 104 to the phosphor layer 102 to be, for example, 4 mm to 7 mm.

An exemplary composition of phosphors in the phosphor layer 102 is as follows: BaMg₂Al₁₆O₂₇:Eu²⁺ (BAM) is used as blue phosphors particles, BaMg₂Al₁₆O₂₇:Eu²⁺, Mn²⁺ (BAM:Mn²⁺) is used as green phosphor particles, and YVO₄:Eu³⁺ (YVo₄) is used as red phosphor particles. There are no particular restrictions on the composition as long as at least two types of phosphors absorbing 313-nm radiation are included. The following are examples of applicable phosphors that have the property of absorbing 313-nm ultraviolet radiation. There are no limitations on the combination of phosphors.
Blue phosphor: BaMg₂Al₁₆O₂₇:Eu²⁺, Sr₁₀(PO₄)₆Cl₂:Eu²⁺, (Sr, Ca, Ba)₁₀(PO₄)₆Cl₂:Eu²⁺, Ba_{1-x-y}SrₓEu_{y}Mg_{1-z}Mn_{z}Al₁₀O₁₇ (provided that x, y, and z are numbers that satisfy the conditions 0≦x≦0.4, 0.07≦y≦0.25, and 0.1≦z≦0.6, and it is particularly preferable for z to satisfy the condition 0.4≦z≦0.5)
Green phosphor: BaMg₂Al₁₆O₂₇:Eu²⁺,Mn²⁺, MgGa₂O₄:Mn²⁺, CeMgAl₁₁O₁₉: Tb³⁺
Red phosphor: YVO₄:Eu³⁺, YVO₄:Dy³⁺ (emits green and red light)

Note that a mixture of phosphors of different compounds may be used for one color. One example is to use BAM for blue, LAP (does not absorb 313-nm ultraviolet radiation) and BAM:Mn²⁺ for green, and YOX (does not absorb 313-nm ultraviolet radiation) and YVO₄:Eu³⁺ for red. In such a case, the leakage of ultraviolet radiation from the glass bulb can be reliably prevented by adjusting the phosphors such that the phosphors absorbing 313-nm ultraviolet radiation comprise 50% or more of the total weight proportion.

In addition to phosphor particles and a metal oxide, the phosphor layer 102 may include a thickening agent, a binding agent, etc. as necessary.

A material of the glass bulb 104 may be, other than soda glass, a hard borosilicate glass with the following composition.

SiO₂: 68 to 77%

Al₂O₃: 1 to 6%

B₂O₃: 14 to 18%

Li₂O: 0 to 0.6%

Na₂O: 1 to 5%

K₂O: 1 to 6%

MgO: 0.3 to 0.6%

CaO: 0.6 to 1%

SrO: 0 to 0.5%

BaO: 0 to 1.3%

Sb₂O₃: 0 to 0.7%

As₂O₃: 0 to 0.2%

TiO₂: 0.4 to 6%

ZrO₂: 0 to 0.2%

Note that the glass bulb 104 is not limited to borosilicate glass. Lead glass, lead-free glass, soda glass, or the like may be used. In this case, it is possible to improve an in-dark starting characteristic of the lamp. Specifically, glasses such as the above contain a large amount of alkali metal oxides such as sodium oxide (Na₂O), and in the exemplary case of sodium oxide, the sodium (Na) component elutes to the inner side of the glass bulb over time. The sodium that elutes to the inner ends of the glass bulb (without a protective film) is thought to contribute to improvement in the in-dark starting characteristic since sodium has a low electronegativity.

Particularly in external electrode fluorescent lamps in which external electrodes are formed so as to cover outer circumferences of the ends of the glass bulb, it is preferable for 3 mol % to 20 mol % of alkali metal oxides to be included in the glass bulb material.

For example, if the alkali metal oxide is yttrium oxide, it is preferable for 5 mol % to 20 mol % of yttrium oxide to be included in the glass bulb material. If the yttrium oxide content is less than 5 mol %, there is a higher probability that the in-dark starting time will exceed one second (in other words, there is a higher probability that the in-dark starting time will be less than one second if the yttrium oxide content is 5 mol % or more). If the yttrium oxide content is more than 20 mol %, there may be problems such as reduced luminance from whitening of the glass bulb due to long-term use, and a reduction in the strength of the glass bulb.

Also, it is preferable to use lead-free glass if environmental protection is taken into consideration. However, lead-free glass may acquire lead as an impurity in the manufacturing process. Lead-free glass is therefore defined as glass that contains lead at an impurity level of 0.1 wt % or less.

While there are no particular restrictions on measurements of the glass bulb 104, it is suitable for a bulb length L to be, for example, 39 mm to 1300 mm. If the glass bulb 104 is composed of borosilicate glass, an inner diameter of 1.2 mm to 3.8 mm and an outer diameter of 1.8 mm to 4.8 mm are preferable considering cost and the like. If the glass bulb 104 is composed of soda glass, an inner diameter of 3.0 mm to 13.4 mm and an outer diameter of 4.0 mm to 15.0 mm are preferable considering mechanical strength.

Electrical current density is greater in the fluorescent lamp 100 using the glass bulb 104 with a small inner diameter, compared with a fluorescent lamp using a glass bulb with a larger inner diameter. This narrowing of the diameter and increase in current density cause an increase in the proportion of emitted 185-nm ultraviolet radiation, which is one of the resonance lines generated along with the excitation of mercury. Given that shorter-wavelength resonance lines in particular degrade phosphors, an increase in the proportion of emitted shorter-wavelength resonance lines causes an increase in the luminance reduction rate during operation of the fluorescent lamp 100. The percentage of mercury consumed also increases, thereby further increasing the luminance reduction rate.

Employing a phosphor layer in which phosphor particles are spanned by rod-shaped bodies composed of a metal oxide is, therefore, very beneficial for the fluorescent lamp 100 whose glass bulb 104 has a small inner diameter of, for example, 1.2 mm to 13.4 mm.

An appropriate amount of, for example, mercury (not depicted) and one or more types of rare gases are enclosed in the glass bulb 104. It is suitable for, for example, 1 mg to 4.8 mg of mercury to be enclosed in the glass bulb 104. The rare gases may be, for example, argon (Ar) gas, neon (Ne) gas, or the like. It is suitable for a mixture ratio of these gases to be, for example, 90 to 95 vol % of Ne gas and 50 to 10 vol % of Ar gas. It is suitable for a gas pressure while the fluorescent lamp 100 is not operated to be, for example, 6.3 kPa to 20 kPa.

The lead wires 103 are composed of, for example, inner lead wires 103a disposed in the glass bulb 104, and outer lead wires 103b that are joined to the lead wires 103a and disposed outside the glass bulb 104. The inner lead wires 103a are composed of, for example, tungsten (W), and the outer lead wires 103b are composed of, for example, nickel (Ni).

The electrodes 106 are bottomed cylinders, and also called hollow electrodes. The electrodes 106 are joined to the lead wires 103 by a laser welding method or the like. The electrodes 106 include an emitter (not depicted) that is retained on an inner side of the bottomed cylinder. The bottomed cylinder is composed of, for example, niobium (Nb), nickel (Ni), or the like, and Cs₂AlO₃ or the like is used in the emitter.

A size of the electrodes 106 is set such that their effective surface area contributing to discharge is a desired size. For example, the electrodes 106 may have a length N in the axial direction of 3.1 mm to 5.6 mm, and an inner diameter of 1 mm to 2.8 mm. It is suitable for a distance R from an end surface of the glass bulb 104 to a corresponding electrode 106 to be 5 mm to 8.3 mm.

It is preferable for the phosphor particles 102a at a face of the phosphor layer 102 on the discharge space side, as shown in FIG. 10, to not be exposed. In other words, it is preferable for the phosphor particles 102a to be embedded in the phosphor layer 102 such that their surfaces do not form a part of the face on the discharge space side, and for such face to be formed from a metal oxide or the like. In this case, the phosphor particles 102a are isolated from the mercury, and adsorption of the mercury to the phosphor particles 102a is more effectively suppressed.

Using a metal oxide whose transmissivity for 254-nm light is high (e.g., 85% or more) as the metal oxide forming the face on the discharge space side enables 254-nm light to reach the phosphor particles 102a to cause them to emit light. In this case, it is preferable for the metal oxide to be, for example, SiO₂, Al₂O₃, HfO₂, ZrO₂, V₂O₅, Y₂O₃, NbO₅, or the like.

A continuous metal oxide layer 105 may be formed between the glass bulb 104 and the phosphor layer 102, as shown in FIG. 11. In this case as well, the glass bulb 104 is isolated from the mercury, thereby suppressing the consumption of mercury by being diffused in the glass bulb 104. If the glass bulb 104 is composed of, for example, soda glass which includes a large proportion of Na, it is possible to suppress the generation of an amalgam due to a reaction between the Na and the mercury. The metal oxide constituting the metal oxide layer 105 may be at least one member selected from among, for example, Y, La, Hf, Mg, Si, Al, P, B, V and Zr. The metal oxide constituting the metal oxide layer 105 may be the same metal oxide as is included in the phosphor layer 102, or a different metal oxide, but it is particularly preferable to use SiO₂, Al₂O₃ or the like.

Although described using the example of a cold-cathode fluorescent lamp, the fluorescent lamp of the present invention is not limited to this. For example, the present invention may be similarly applied to an external electrode fluorescent lamp, a hot-cathode fluorescent lamp, a compact fluorescent lamp, an electrodeless fluorescent lamp using an external dielectric coil, or the like.

### 2.3 Manufacturing Method for a Cold-Cathode Fluorescent Lamp

The following describes an exemplary manufacturing method for the fluorescent lamp described above.

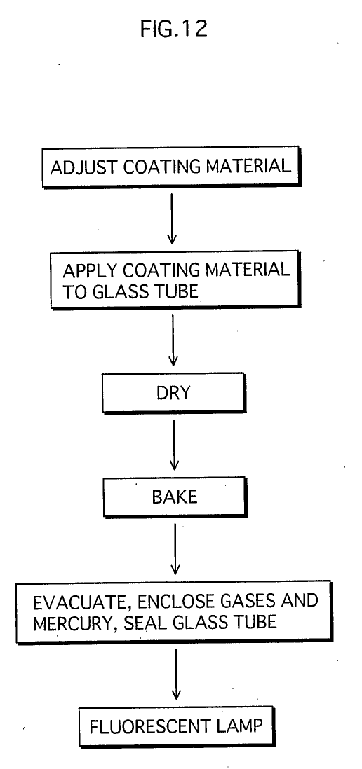

As shown in FIG. 12, a coating material for forming the phosphor layer 102 is first adjusted. Adjusting the coating material involves dispersing a predetermined amount of phosphor particles in a solvent, and adding and dissolving a predetermined amount of a metal compound into the obtained suspension. The solvent used here includes two or more types of organic solvents that have different boiling points. More specifically, the two or more types of solvents with different boiling points need only be appropriately selected from among butyl acetate (boiling point is 120 to 126.5° C.), ethanol (boiling point is 78.3° C.), methanol (boiling point is 64.6° C.), turpentine (boiling point is 150 to 200° C.), or the like.

Regarding a compound ratio of the two or more types of solvents, it is suitable for a higher boiling point solvent to be 0.1 wt % to 10 wt % based on 100 wt % of a lower boiling point solvent. It is more suitable for the high boiling point solvent to be 2 wt % to 6 wt %. It is possible to adjust the average thickness of the rod-shaped bodies to a desired value by adjusting the mixture ratio of the lower boiling point solvent and the higher boiling point solvent.

While there are no particular restrictions on the amount of the metal compound to be added, it is preferable for the metal compound to be added such that, for example, the metal oxide obtained by a reaction with the metal compound makes up approximately 0.1 to 0.6 parts per weight of the phosphor layer for 100 parts per weight of phosphor particles. The phosphor layer will have insufficient strength if too little metal oxide is obtained from the reaction with the metal compound, and luminance will be insufficient if there is too much of the metal oxide. Adding an amount of the metal compound such that the metal oxide makes up approximately 0.1 to 0.6 parts per weight for 100 parts per weight of the phosphor particles makes it possible to obtain a phosphor layer that achieves both strength and luminance. While there are no particular restrictions, it is suitable for the amount of the solvent to be, for example, approximately 45 to 120 parts per weight for 100 parts per weight of phosphor particles.

The coating material may include a binding agent, thickening agent, or the like as necessary. The binding agent is, for example, a phosphorous or boron binding agent, and the thickening agent is nitrocellulose or the like. In this case, it is suitable for the amount of the added binding agent to be approximately 0.1 to 2 parts per weight based on 100 parts per weight of phosphor particles, and for the amount of added thickening agent to be approximately 0.3 to 2.5 parts per weight for 100 parts per weight of phosphor particles.

Next, the coating material is applied to the inner side of the glass tube. Application of the coating material to the glass tube is performed using a method of, for example, sucking a liquid up the glass tube which has been stood upright. While there are no particular restrictions, the amount of coating material to be applied is adjusted such that the phosphor layer includes, for example, 2 to 5 mg/cm² of phosphors.

Next, organic solvents included in the applied coating material are vaporized, and the coating layer is dried. At this time, a concentration of the metal compound in the coating material rises (the metal compound solution becomes concentrated) as the solvents in the coating material vaporize, and before long, the metal compound is deposited between the phosphor particles. With the progression of the vaporization, the solution moves to narrower gaps between the phosphor particles due to surface tension. This results in the metal compound being deposited disproportionately in portions where the inter-phosphor particle distance is narrow.

Drying of the coating material is performed, for example, while the glass tube is stood upright, that is, without changing the position of the glass tube after the coating material has been applied. Drying may also be performed while rotating the upright glass tube.

Drying of the coating material may be performed by maintaining an atmosphere in the glass tube in which the solvent readily vaporizes. For example, a gas need only be continuously supplied into the glass tube. While there are no particular restrictions on the amount of gas to be supplied, productivity falls if too little gas is supplied, and supplying too much gas inhibits the formation of a highly uniform phosphor layer. It is therefore suitable for the gas supply rate to be more than 0 ml/min/cm² and up to 64 ml/min/cm², and more preferably 16 to 48 ml/min/cm². Note that it is not necessary for the solvent to be completely removed. A small amount of the solvent may remain.

As is shown in working example 2 which is mentioned hereinafter, it is preferable to supply a gas with a humidity of 10% to 40% at 25° C. into the glass tube while drying the coating material. It is unclear why, but uniformity of the thickness etc. of the phosphor layer 102 deteriorates if the humidity in the glass tube is too low. Specifically, gaps form in the phosphor layer 102 as if slippage occurred during drying of the coating material, and this causes unevenness in the phosphor layer 102. On the other hand, vaporization of the solvents takes too long if the humidity is too high, thereby reducing production efficiency. Supplying the above gas in the glass tube while vaporizing the solvents enables the efficient formation of the phosphor layer 102 with excellent uniformity of thickness and the like. It is also possible to provide the fluorescent lamp 100 which has little luminance variation, by improving the uniformity of the phosphor layer 102.

Next, the dried coating material, is baked. A sinter furnace, electric furnace, or the like may be used to raise an internal temperature of the glass tube to approximately 600° C. to 700° C.

Next, the interior of the glass tube is evacuated, mercury and rare gases are filled therein, and both ends of the glass tube are sealed, as is normally performed, thereby obtaining the glass bulb 104

The metal compound included in the coating material can be, for example, an organic metal compound such as yttrium carboxylate (Y(CₙH₂ₙ₊₁COO)₃, 5≦n≦8), yttrium isopropoxide (Y(OC₃H₇)₃), tetraethoxysilane (Si (OC₂H₅)₄), etc., or a metal nitrate, a metal sulfate, a metal carboxylate, a metal beta-diketonate complex, or the like.

The following describes a reaction in which a metal compound becomes a metal oxide, taking an example in which yttrium caprylate (Y(C₇H₁₅COO)₃) is used as the metal compound.

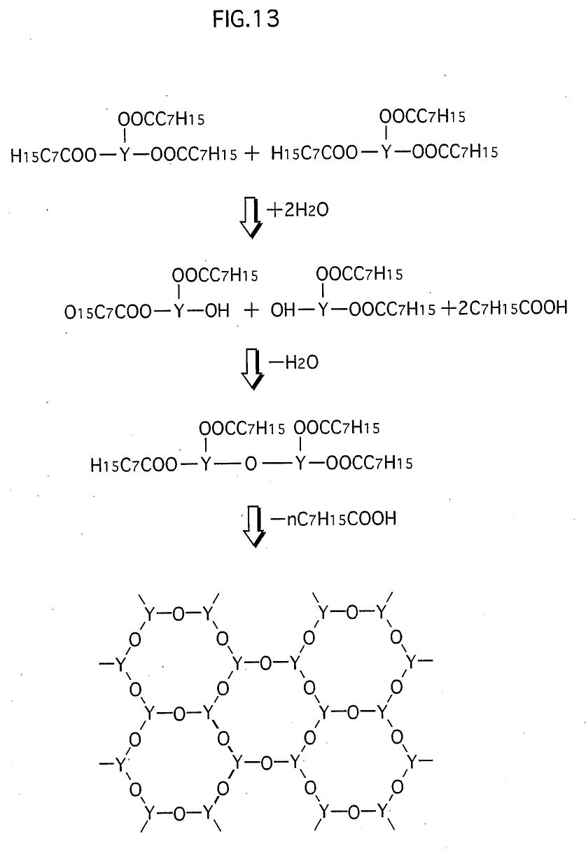

As shown in FIG. 13, in the yttrium caprylate, the caprylate group (—OOCC₇H₁₅) is replaced by the hydroxide group (—OH) due to hydrolysis, and C₇H₁₅COOH is simultaneously produced. The resultant yttrium compound is dehydrated to cause polymerization. After this reaction has been repeated, the polymer is baked and annealed. This is how yttrium caprylate becomes yttrium oxide (Y₂O₃).

Note that, for example, the ratio etc. of the metal compound included in the coating material for formation of the phosphor layer need only be adjusted in order to keep the phosphor particles 102a from being exposed on the face of the phosphor layer 102 on the discharge space side. Alternatively, in addition to the coating material for formation of the phosphor layer, there may be provided another coating material that contains the above metal compound but does not include phosphor particles, and the phosphor layer may be formed by applying the latter coating material after drying the former coating material but before baking. A formation method of the metal oxide layer 105 is the same. The latter metal compound-containing coating material includes, for example, the components of the coating material for formation of the phosphor layer, with the exception of phosphor particles.

### 2.4 Structure of a Backlight Unit

Next is a description of an exemplary lighting device including an external electrode fluorescent lamp. The following describes an example of a backlight unit included in a liquid crystal display (LCD) apparatus, as the exemplary lighting device. However, the present invention is not limited to this, and may be used in any known display apparatus that requires a lighting device. Also, although the following describes a direct-type backlight unit in which a plurality of fluorescent lamps are arranged in parallel on a back face of an LCD panel, the lighting device of the present embodiment may be an edge-light backlight unit in which a fluorescent lamp is disposed on an edge surface of a light guide plate mounted to the back face of the LCD panel.

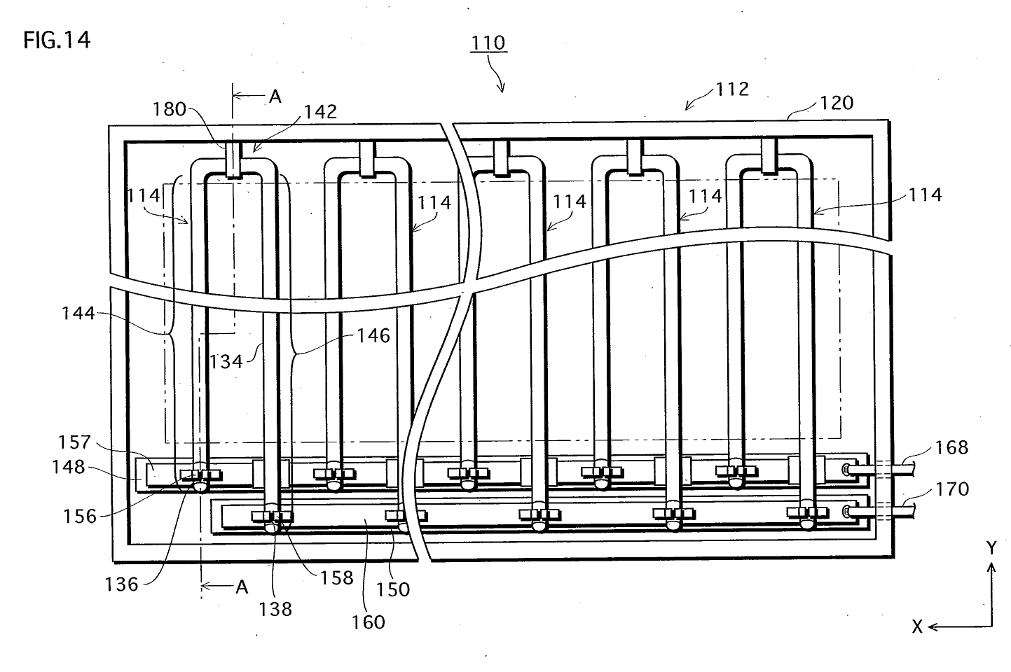

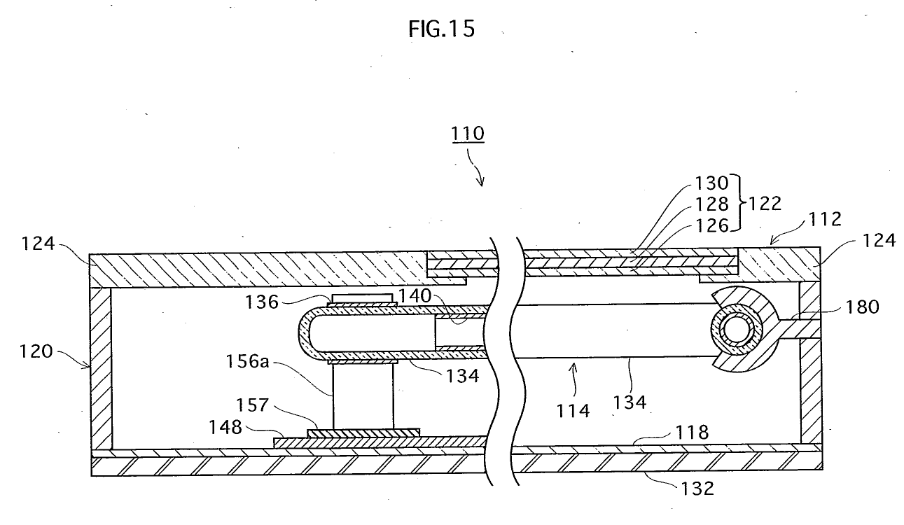

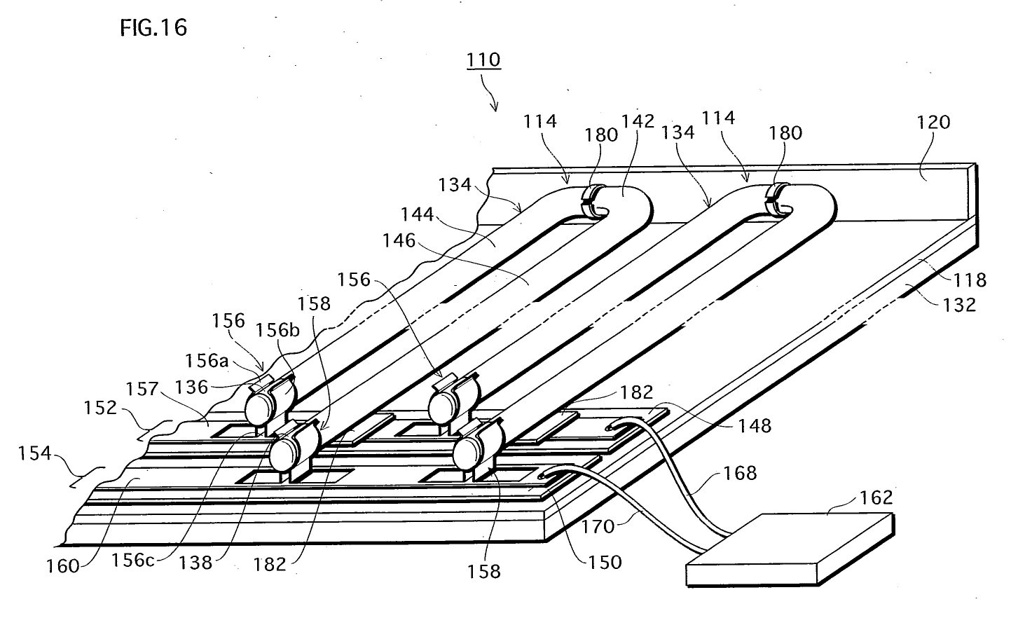

FIG. 14 is a plan view showing a schematic structure of a backlight unit 110 of the present embodiment, FIG. 15 is an enlarged cross-sectional view taken along A-A of FIG. 14, and FIG. 16 is a perspective view of the backlight unit 110 of the present embodiment. Note that FIGS. 14 and 16 show the backlight unit 110 in a state in which a light transmitting plate 122 shown in FIG. 15, a mounting frame 124 for mounting the light transmitting plate 122, and the like have been excluded. Also, the scale between constituent elements is not the same in FIGS. 14, 15, and 16.

As shown in FIGS. 14 and 15, the backlight unit 110 includes a casing 112 which stores a plurality of exemplary fluorescent lamps 114 of the present invention. The fluorescent lamps 114 are U-shaped curved external electrode fluorescent lamps (EEFLs).

The casing 112 includes, for example, a reflecting plate 118, side walls 120 that are vertically arranged on a periphery of the reflecting plate 118, a mounting frame 124 that is mounted to the side walls 120 in opposition to the reflecting plate 118, and the light transmitting plate 122. The light transmitting plate 122 is mounted in the mounting frame 124, and is disposed parallel to the reflecting plate 118. The light transmitting plate 122 includes a light diffusing plate 126, a light diffusing sheet 128, and a lens sheet 130 which are laminated in order from the reflecting plate 118 side (the fluorescent lamp 114 side). Given that the mounting frame 124 is formed from a non-light transmitting material, light generated from the fluorescent lamps 114 is emitted from an area enclosed by a dashed double-dotted line in FIG. 14 where the light transmitting plate 192 is. In other words, the light transmitting plate 122 functions as a window able to transmit light emitted by the fluorescent lamps 114.

The fluorescent lamps 114 are dielectric barrier discharge fluorescent lamps which are provided with external electrodes 136 and 138 around an outer circumference of end portions of glass bulbs 134, and use the glass bulb walls as capacitors. The external electrodes 136 and 138 are formed by, for example, winding a metal foil such as aluminum foil or copper foil around the outer circumference of the glass bulbs 134, vapor depositing metal on a surface of the glass bulbs 134, or applying a conductive paste and baking.

A phosphor layer 140 is formed on an inner side of each of the glass bulbs 134. However, the phosphor layer 140 is not formed on portions of the inner side where the glass bulb 134 contacts the external electrodes 136 and 138, in order to suppress a significant depletion of the mercury enclosed in the glass bulb 134. Materials of the phosphor layer 140 and a formation method thereof are the same as in the case of the previously mentioned cold-cathode fluorescent lamp 100. Mercury (not depicted) is added into the glass bulb 134, and a mixed gas (not depicted) including neon and argon is enclosed as a discharge material (discharge gas).

Each of the glass bulbs 134 has a U-shaped curved part 142, and a first straight part 144 and a second straight part 146 which are arranged extending parallel out from the curved part 142. The second straight part 146 is made longer than the first straight part 144, in order to reach a position where a hereinafter-mentioned second connector 158 is disposed.

As shown in FIG. 16, two elongated insulating plates (a first insulating plate 148 and a second insulating plate 150) are laid substantially parallel on a top surface of the reflecting plate 118. The first and second insulating plates 148 and 150 are composed of, for example, polycarbonate. Note that, alternatively, in the present example, a single insulating plate with an area that is about the same as a total area of the first and second insulating plates 148 and 150 may be used. A top surface of the first insulating plate 148 is provided with a first feeder 152 for supplying power to the first external electrode 136, and a top surface of the second insulating plate 150 is provided with a second feeder 154 for supplying power to the second external electrode 138.

The first feeder 152 is composed of a plurality of first connectors 156, and a first plate 157 that physically links and electrically connects the first connectors 156. The number of first connectors 156 corresponds to the number of fluorescent lamps 114. The first plate 157 is attached to the top surface of the first insulating plate 148. An external electrode 136 (hereinafter, may be called a “first external electrode 136” for distinction from the external electrode 138) is fitted into each of the first connectors 156. The first connectors 156 include clamp pieces 156a and 156b, and a plate-shaped part (link 156c) that links the clamp pieces 156a and 156b. A remaining portion of plate-shaped part not included the first connector 156 constitutes the first plate 157. The clamp pieces 156a and 156b can be formed by, for example, performing the following process on an elongated plate material composed of a conductive material such as phosphor bronze or the like. The plate material is scored so as to leave one adjoining side of two consecutive rectangles in the longitudinal direction. A pair of cantilever pieces formed in this way are folded to be substantially perpendicular to the plate material, and an end of each of the cantilever pieces is given a shape that conforms to the outer circumference of the fluorescent lamps. The clamp pieces 156a and 156b bend outward when the first electrode 136 is fitted into the first connector 156, and the first electrode 136 is held in the first connector 156 due to the restoring force of the clamp pieces 156a and 156b.

Similarly, the second feeder 154 is composed of a plurality of second connectors 158, and a second plate 160 that physically links and electrically connects the second connectors 158.

Areas of the first plate 157 that pass under the second straight parts 146 of the glass bulbs 134 are covered by insulating sheets 182. The insulating sheets 182 are composed of an insulating material such as polycarbonate or the like.

In the example shown in FIG. 16, portions of the second straight parts 146 that are closer to the second external electrodes 138 pass over the first plate 157 which is electrically connected to the first external electrodes 136. There is therefore a large difference in electrical potential where the second straight parts 146 and the first plate 157 intersect. Consequently, leakage current will flow from the higher potential area to the lower potential area where the second straight parts 146 and the first plate 157 intersect, if the insulating sheets 182 are not provided, and this becomes a cause for luminance reduction in the fluorescent lamps 114. It is therefore preferable to arrange the insulating sheets 182 at the points of intersection to suppress the leakage of current as much as is possible.

The backlight unit 110 includes an inverter 162 which is electrically connected to the first plate 157 and the second plate 160 via lead wires 168 and 170. The inverter 162, which is a power supply circuit unit, converts 50/60 Hz AC power from a commercial power supply (not depicted) into high-frequency power, and supplies the high-frequency power to the fluorescent lamps 114. Thus, power is supplied over 2 conductive lines to the fluorescent lamps 114 via the first plate 157 and the second plate 160, and it is possible to operate the plurality of fluorescent lamps 114 in parallel using the one inverter 162.

Curved support members 180 having “C” shaped parts are mounted to one of the side walls 120 in correspondence with the fluorescent lamps 114. The curved support members 180 are composed of, for example, a resin such as polyethylene terephthalate (PET) or the like. Mounting the fluorescent lamps 114 into the casing 112 is simple since it is only necessary to fit the curved parts 142 of the glass bulbs 134 into the “C” shaped parts, then fit the first and second external electrodes 136 and 138 that are formed around an outer circumference of the ends of the glass bulbs 134 into the first and second connectors 156 and 158 respectively.

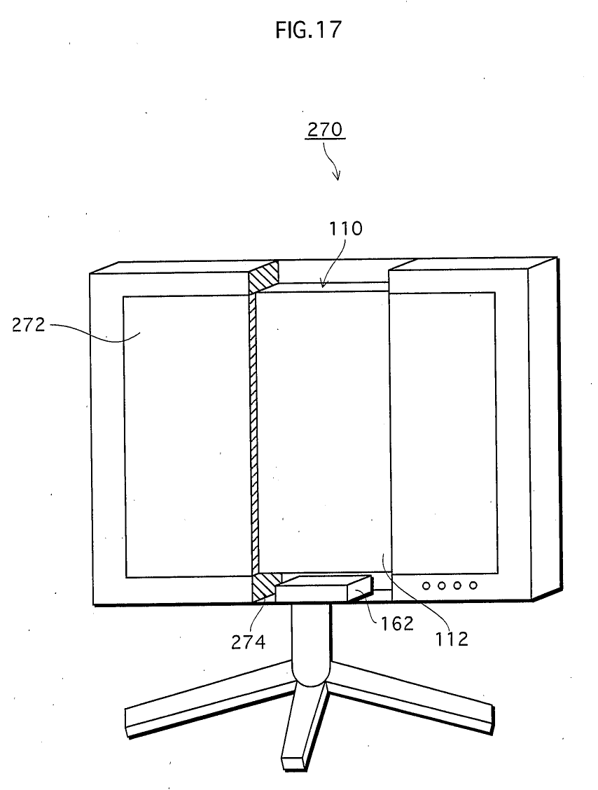

FIG. 17 shows an exemplary liquid crystal television as an example of a display apparatus using the backlight unit 110 of the embodiments. In FIG. 17, a portion of a front surface of a liquid crystal television 270 has been cut away for convenience in the description. The liquid crystal television 270 is, for example, a 32-inch liquid crystal television, and includes a liquid crystal display panel (LCD) 272 etc. in addition to the backlight unit 110. The LCD panel 272 is composed of a color filter substrate, a liquid crystal, a TFT substrate etc., and is driven by a drive module (not depicted) to form color images based on an external image signal.

The casing 112 of the backlight unit 110 is disposed on a back face side of the LCD panel 272, and the backlight unit 110 radiates light from the back face to the LCD panel 272. The inverter 162 is disposed outside the casing 112, such as, for example, in a housing 274 of the liquid crystal television 270.

### 2.5 Working Examples of a Manufacturing Method for a Cold-Cathode Fluorescent Lamp

The following more specifically describes examples of the present invention using working examples. Note that the present invention is not limited to the following working examples.

### First Working Example

In the first working example, a cold-cathode fluorescent lamp with the structure shown in FIG. 9 was made in the following way. First, there were provided YVO₄:Eu³⁺, BaMg₂Al₁₆O₂₇: Mn²⁺, Eu²⁺, and BaMg₂Al₁₆O₂₇:Eu²⁺ as three-wavelength phosphors. A mixture ratio of these three phosphors was adjusted such that a chromaticity thereof was x=0.220, y=0.205. 1 kg of the three-wavelength phosphors was dispersed in a mixed solvent composed of butyl acetate and turpentine to obtain a suspension. Before dispersal of the phosphors, 15 g of NC (nitrocellulose) and 1.5 g of a boric acid binding agent were dissolved in the mixed solvent. A mixture ratio of the butyl acetate and turpentine in the mixed solvent was 900 g of butyl acetate to 4 g of turpentine. Yttrium caprylate was added to the suspension and dissolved by stirring, thereby obtaining a coating material for formation of the phosphor layer. 15 g of yttrium caprylate was added for 1 kg of phosphor particles.

Next, the coating material was applied to an inner side of a glass tube having an inner diameter of 2.4 mm, a length of 400 mm, and a wall-thickness of 0.2 mm. Application of the coating material to the glass tube was performed using a method of sucking a liquid up the upright glass tube. A composition of the glass tube was as follows.

SiO₂: 69.3%

Al₂O₃: 5.1%

B₂O₃: 15.5%

Li₂O: 0.48%

Na₂O: 1.4%

K₂O: 4.8%

MgO: 0.5%

CaO: 0.9%

SrO: 0.04%

BaO: 1.2%

Sb₂O₃: 0.1%

As₂O₃: 0%

TiO₂: 0.6%

ZrO₂: 0.1%

Next, air with a relative humidity of 12% at 25° C. was supplied into the glass tube for approximately eight minutes to dry a layer composed of the applied coating material. This drying of the layer was performed while rotating the upright glass tube. The warm air was supplied at a rate of 30 ml/min/cm². Then baking was performed using an electric furnace set to 670° C. The baking time was ten minutes. At this time, the temperature inside the glass tube reached 650° C. when measured using a thermocouple.

Next, the interior of the glass tube was evacuated, gases (Ne:Ar=95:5, at approximately 8 kPa) and 3 mg of mercury were enclosed therein, and the glass tube was sealed, thereby obtaining a fluorescent lamp (a).

Note that Nb was used in the material of the electrodes. The electrodes had a length N in the axial direction of 5.5 mm, an inner diameter of 1.7 mm, and a wall-thickness of 0.1 mm. A distance M from an end surface of the glass bulb to the electrode is 8.2 mm. Cs₂AlO₃ was used in the emitter.

Upon observing a 300 μm square area of the phosphor layer using an HRSEM, it was apparent that the phosphor particles were spanned by rod-shaped metal oxide bodies (rod-shaped bodies) with a thickness of 0.2 μm to 1.5 μm. In some portions, pairs of phosphor particles were spanned by a plurality of the rod-shaped bodies. The rod-shaped bodies had an average thickness of 0.5 μm.

Note that the “average thickness” of the rod-shaped bodies is an arithmetic average value of thicknesses measured at ½ of the longitudinal length of the plurality of rod-shaped bodies in the 300 μm square area of the phosphor layer that was observed using the HRSEM.

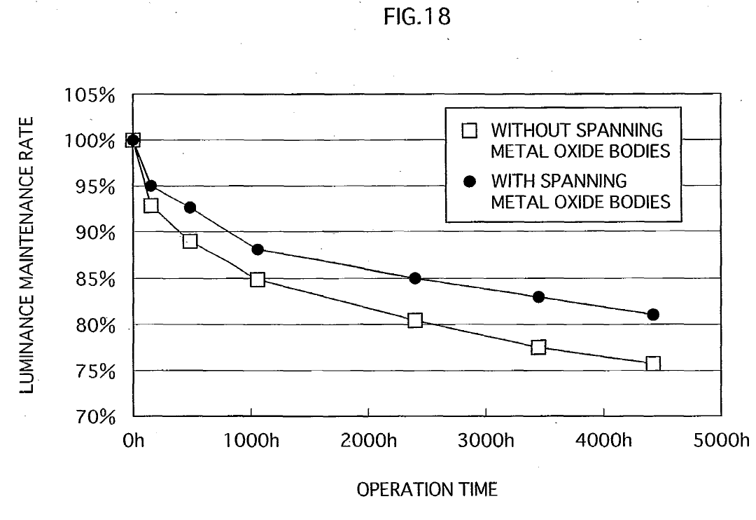

Upon measuring the luminance of the lamp using a spectroradiometer (made by TOPCON, Model No. SR-3), the initial luminance was 22,950 cd/m². In FIG. 18, the initial luminance is 100%, and luminance maintenance rates with respect to elapsed operation time are represented by a black circle (). Note that for comparison, there was provided another lamp having the same specifications, but lacking spanning metal oxide bodies. This lamp had an initial luminance of 22,480 cd/m², and maintenance rates with respect to elapsed operation time for this lamp are represented in FIG. 18 as a white square (□). As shown in FIG. 18, the lamp without spanning metal oxide bodies had a luminance maintenance rate of about 80% at 2,400 hours of operation, while the lamp of the present working example had a luminance maintenance rate of about 85%. It is apparent that the luminance maintenance rate has been improved.

### Second Working Example

In the second working example, fluorescent lamps (c) to (g) were made in the same way as in the first working example, except for changing the temperature of the gas supplied into the glass tube while drying the coating layer.

Gases with humidities of 40%, 15%, 10%, 8% and 5% at 25° C. were used for the fluorescent lamps (c) to (g) respectively. In the present invention, the humidity in the glass tubes was therefore kept at 40%, 15%, 10%, 8% and 5% while the gas was being supplied.

Uniformity of the thicknesses of the phosphors layers was examined for the fluorescent lamps (c) to (g). First, an HRSEM was used to observe the phosphor layer over an entire length in the longitudinal direction of each of the fluorescent lamps. A larger variation in thickness of the phosphor layer was observed in the fluorescent lamps (g) and (f), in which the coating material was dried using a gas with a humidity of less than 10% at 25° C., compared with the fluorescent lamps (c) to (e) in which the coating material was dried using a gas with a humidity of 10% to 40% at 25° C. Specifically, unevenness was observed in the phosphor layers of the fluorescent lamps (g) and (f) due to gaps appearing in the phosphors layers as though the coating material slipped during drying. On the other hand, the thicknesses of the phosphor layers of the fluorescent lamps (c) to (e) were substantially constant (18 μm plus or minus 2 μm) over the entire length in the longitudinal direction.

### Supplementary Remarks

Red Phosphor YVO₄:Eu³⁺

Although it was not particularly mentioned in detail in embodiments 1 or 2, when YVO₄:Eu³⁺ (YVO) is used as the red phosphor, it is preferable for a concentration of impurities such as mainly iron (Fe), silicon (Si), and calcium (Ca) to be at or below a predetermined value.

The red phosphor YVO has a chromaticity of x=0.661, y=0.328, and is used to improve color reproducibility.

The inventors of the present invention found, however, that with conventional YVO, the red radiation intensity tends to not sufficiently rise compared with the green and blue radiation intensities, regardless of a rise in the electrical current of the lamp.

For this reason, it is clear that a luminance commensurate with the rise in electrical current cannot be obtained, and furthermore, only the red component of the 3-color light weakens as the electrical current of the lamp rises, thereby resulting in a color shift in the light emitted by the lamp.

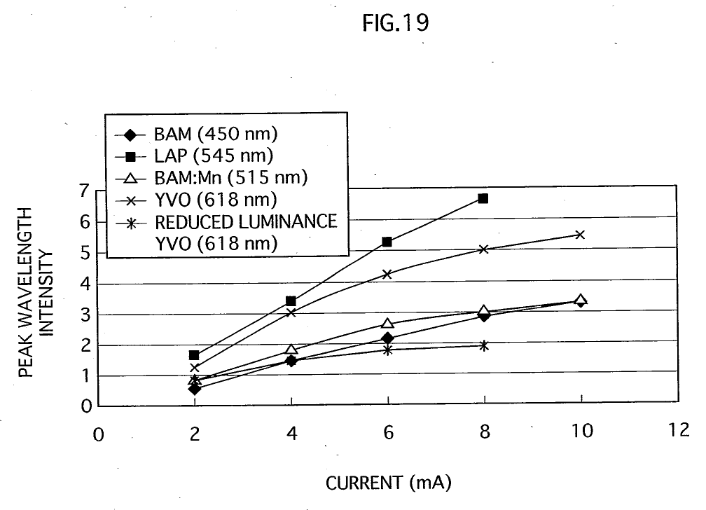

FIG. 19 is a graph showing a relationship between lamp current (mA) and peak wavelength intensity, in the case of making and operating lamps with the same structure as the cold-cathode fluorescent lamp 100, but having phosphor layers formed from single-color phosphors.

In the graph of FIG. 19, “Reduced Luminance YVO” is YVO with an impurity concentration of 33 ppm, and simple “YVO” is YVO with an impurity concentration of 9 ppm.

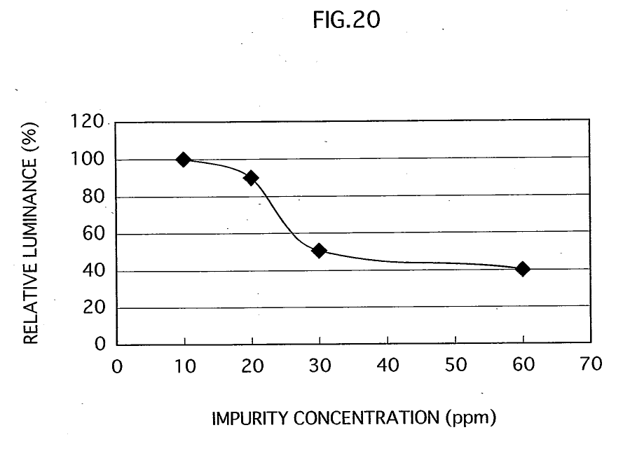

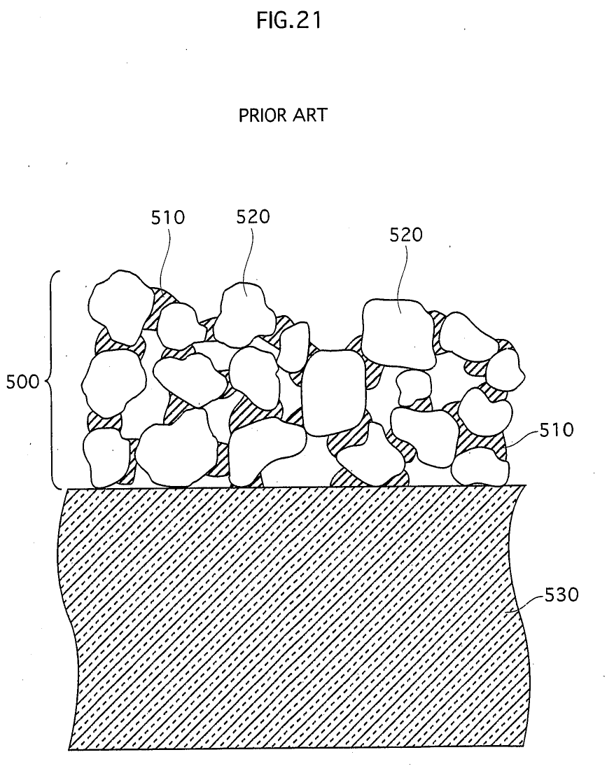

Note that impurity concentrations in FIG. 19 and the later-mentioned FIG. 20 were measured using an ICP spectrometer (ICPS-8000) manufactured by Shimadzu Corporation.

As shown in the graph of FIG. 19, the peak wavelength intensity of the “Reduced luminance YVO” does not rise very much regardless of a rise in the electrical current, and therefore deviates from the rate of increase of the blue phosphor (BAM), the green phosphor (BAM:Mn²⁺), and the green phosphor (LAP). Color shift therefore readily occurs in a lamp that uses these 3 colors of phosphors.

In contrast, the peak wavelength intensity of “YVO” increases with a rise in the electrical current value, therefore making it possible to suppress color shift.

Note that the value of the electrical current in the cold-cathode fluorescent lamps is in the practical range of 4.0 mA to 8.0 mA. For this reason, it is necessary for the rate of increase for the red phosphor in this range to not deviate from that of the other phosphors, in order to prevent color shift.

FIG. 20 is a graph showing a relationship between relative luminance (%) and the impurity concentration (ppm) of Fe, Si, and Ca in the red phosphor YVO₄:Eu³⁺, in the case of making a lamp with the same structure as the cold-cathode fluorescent lamp 100, but having a phosphor layer formed from 3 colors of phosphors that include the red phosphor YVO₄:Eu³⁺, and operating the lamp at an electrical current of 6 mA. A luminance with an impurity concentration of 10 ppm is used as the basis for the relative luminance (%).

As shown in FIG. 20, the relative luminance is 90% when the impurity concentration is 20 ppm, but drastically falls to 50% when the impurity concentration is 30 ppm.

It is preferable for the impurity concentration to be 20 ppm or less, in light of the practical range of electrical current values and the above-mentioned color shift problem. The lower the impurity concentration the better, but a minimum value is, for example, 3 ppm, in consideration of purification technology for removing impurities, and problems during manufacturing process.

It is therefore preferable for the impurity concentrations of Fe, Si, and Ca in YVO to be 3 ppm to 20 pmm inclusive.

The following is thought to be the cause for improved results when using YVO having a reduced concentration of particularly Fe, Si, and Ca.

Specifically, when the red phosphor YVO is contaminated with large amounts of Fe, Si, and Ca, the Fe, Si, and Ca on the surface of the YVO red phosphor particles readily becomes negatively charged due to their relatively high electronegativity (1.8, 1.8, and 1.0 respectively).

Hg⁺ is therefore trapped on the surface of the red phosphor particles, the amount of mercury in the discharge space decreases, and the above-mentioned color shift occurs.

### INDUSTRIAL APPLICABILITY

A fluorescent lamp pertaining to the present invention makes it possible to prevent ultraviolet radiation with a wavelength of 313 nm from leaking out of the lamp, and can be used in a backlight unit or the like.

1. A fluorescent lamp comprising:
a glass bulb having mercury enclosed therein; and
a phosphor layer formed on an inner side of the glass bulb and including three types of phosphor particles, the three types of phosphor particles being red phosphor particles, green phosphor particles and blue phosphor particles that are excited by ultraviolet radiation to emit red light, green light and blue light respectively, wherein
at least two types of phosphor particles from among the three types of phosphor particles have a property of absorbing ultraviolet radiation with a wavelength of 313 nm.

2. The fluorescent lamp of claim 1, wherein
one of the at least two types of phosphor particles that absorb ultraviolet radiation with a wavelength of 313 nm is the blue phosphor particles, and
the blue phosphor particles are Eu-activated barium magnesium aluminate phosphor particles.

3. The fluorescent lamp of claim 1, wherein
one of the at least two types of phosphor particles that absorb ultraviolet radiation with a wavelength of 313 nm is the green phosphor particles, and
the green phosphor particles are Eu/Mn-activated barium magnesium aluminate phosphor particles.

4. The fluorescent lamp of claim 1, wherein the at least two types of phosphor particles compose 50% or more by weight of a total weight composition of the three types of phosphor particles.

5. The fluorescent lamp of claim 1, wherein a thickness of the phosphor layer is in a range of 14 μm to 25 μm inclusive.

6. The fluorescent lamp of claim 1, wherein the glass bulb is borosilicate glass which has a property of absorbing ultraviolet radiation with a wavelength of 254 nm.

7. The fluorescent lamp of claim 1, wherein yttrium oxide protective films have been formed between the phosphor particles and on surfaces thereof.

8. A backlight unit including the fluorescent lamp of claim 1.

9. A liquid crystal display apparatus, comprising:
a liquid crystal display panel; and
the backlight unit of claim 8.

10. A direct-type backlight unit, comprising:
a plurality of the fluorescent lamps of claim 1; and
a diffusion plate disposed on a light extracting side, and being a polycarbonate resin.

11. The fluorescent lamp of claim 1, wherein the phosphor layer has rod-shaped bodies that include a metal oxide material and span between phosphor particles of the three types of phosphor particles.

12. The fluorescent lamp of claim 11, wherein among the phosphor particles, at least one pair of adjacent phosphor particles is spanned by a plurality of the rod-shaped bodies.

13. The fluorescent lamp of claim 11, wherein a thickness of each of the rod-shaped bodies is no more than 1.5 μm.

14. The fluorescent lamp of claim 11, wherein the metal oxide includes at least one member selected from the group consisting of Y, La, Hf, Mg, Si, Al, P, B, V and Zr.

15. The fluorescent lamp of claim 11, wherein the metal oxide includes Y₂O₃.

16. The fluorescent lamp of claim 11, wherein an inner diameter of the glass bulb is in a range of 1.2 mm to 13.4 mm inclusive.

17. A manufacturing method for a fluorescent lamp, comprising:
a phosphor layer formation step of
applying a coating material to an inner side of a translucent container, the coating material including a solvent that includes dispersed phosphor particles and a dissolved metal compound,
vaporizing the solvent included in the applied coating material, and
heating the coating material such that the compound metal becomes a metal oxide, to form a phosphor layer in which the phosphor particles are spanned by rod-shaped bodies that include the metal oxide; and
a mercury enclosing step of, after formation of the phosphor layer, enclosing mercury in the translucent container, wherein
the solvent includes two or more types of solvents that each have a different boiling point.

18. The manufacturing method for a fluorescent lamp of claim 17, wherein the metal compound is an organic metal compound.

19. The manufacturing method for a fluorescent lamp of claim 18, wherein the organic metal compound includes yttrium carboxylate.

20. The manufacturing method for a fluorescent lamp of claim 19, wherein in the phosphor layer formation step, gas with a humidity in a range of 10% to 40% at 25° C. is supplied into the translucent container while vaporizing the solvent.
